(19) United States
(12) Patent Application Publication
(10) Pub. No.: US 2008/0270905 A1
(43) Pub. Date: Oct. 30, 2008

(54) Generation of Media Presentations Conforming to Templates

(76) Inventor: Daniel M. Goldman, Piedmont, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/061,758

(22) Filed: Apr. 3, 2008

Related U.S. Application Data
(60) Provisional application No. 60/913,816, filed on Apr. 25, 2007.
(60) Provisional application No. 60/913,989, filed on Apr. 25, 2007.
(60) Provisional application No. 60/972,452, filed on Sep. 14, 2007.

(51) Int. Cl. G06F 3/048

(52) U.S. Cl. 715/721; 715/716

(57) ABSTRACT

Creation and manipulation of a media presentation. A user may answer one or more questions in a questionnaire. A media presentation may be generated based on the questionnaire. Alternatively, a media presentation template or wizard may be presented to the user for completion of the media presentation (independent of or in response to completion of the questionnaire). The user may choose from one or more media assets associated with segments of the media presentation. The media assets may be presented for display as icons which represent the media assets. The media presentation may be created and provided to the user.

### PRIORITY CLAIM

The present application claims priority to provisional application Ser. Nos. 60/913,816, titled “Media Creation Software Application” and filed Apr. 25, 2007; 60/913,989, titled “Media Creation Software Application” and filed Apr. 25, 2007; and 60/972,452 and filed Sep. 14, 2007, titled “System for Generation of Media Presentations Conforming to Templates”, which are each hereby incorporated by reference as though fully and completely set forth herein.

### FIELD OF THE INVENTION

The present invention relates to software, more particularly, to visual and audio media creation and manipulation software.

### DESCRIPTION OF THE RELATED ART

There are a wide variety of visual and audio manipulation applications available on the market today. Some are moderately easy to use, while others are complicated and more difficult to use. Most media applications allow the user to drag source material in various formats into one of many tracks. In general, the source material is assembled sequentially and merged into an output file. Some software, such as Adobe Premier, discriminates between the type of content (i.e. video, audio and special effects) which is placed in a track.

With the advent of technologies such as Adobe Flash, AJAX, and the beta release of Adobe's Apollo platform, the development of media creation and editing applications has greatly increased, and companies such as JumpCut (video editing), RockYou (slide shows), PhotoBucket (image editing), and JamGlue (music editing), among others, have released media manipulation applications. As the proliferation of tools has increased, the amount of user created content, at all quality levels, has greatly increased. As a result, virtually any user with a computer can create media from home using applications installed locally or accessed via the Internet.

However, creation of media is still difficult (especially for novice users) using the various tools currently available. For example, typically, media creation programs require the user to build media de novo, and do not provide frameworks or templates (e.g., narrative templates) for different media project types.

More specifically, if a user desires to make a media production, for example a short news story or public service announcement, current media creation tools do not provide sufficient assistance to the user. Dramatic productions are often constructed in acts, which occur in sequence and have a known role in the overall production type being made. However, available media creation applications do not arrange media development in acts and provide context or templates for inserting scenes. For example, using current media creation tools, the user does not know how to arrange each of the acts in a production or what elements go in to each act or “segment”. The user does not know which media elements to use, in what order, to create the desired media presentation. The various existing tools have functional terminology, such as “video track”, “transition”, “image”, but do not have conceptual templates designed into their interfaces. Current tools may separate tracks into components such as audio, video, transitions. However, the user may not know what audio, video or text to put in each place on the timeline in order to create the desired media piece. Furthermore, many people are novices at media creation and may be intimidated by current media creation software. The current media creation programs are not organized in a way specifically designed to facilitate the creation of media that is effective for a specific purpose by following one or more templates. The existing applications do not directly guide people in creating content which conforms to known structures for creating specific media content types to serve the consumer's end goal for the media.

Correspondingly, improvements in media creation tools would be desirable.

### SUMMARY OF THE INVENTION

Various embodiments are presented of a system and method for creation of a media presentation.

The method may include displaying a media presentation template. In one embodiment, the media presentation template may correspond to a media presentation type already selected by a user (e.g., from a plurality of media presentation types). The template may include a sequence of segments, where the segments are graphically illustrated on the display. The segments in the sequence may have a first ordering, and, for each of at least a subset of the segments, at least one media asset icon representing a media asset may be associated with the respective segment. Media assets may be video assets (e.g., video media files), audio assets (e.g., audio files), graphics, and/or text, among other media types.

A first segment may include a plurality of selectable media asset icons, where each of the plurality of selectable media asset icons represents a respective media asset usable for the first segment. In some embodiments, the media asset icons may include an image or information which indicates the respective media asset represented by the media asset icon. Additionally, the sequence of segments may be represented on the display by the media asset icons being displayed in a left to right or top to bottom manner, as desired.

However, instead of providing a plurality of selectable media assets, the user may be presented with a template which indicates to the user the purpose of the various acts or segments in the template to assist the user in creating the media presentation. The user may then select appropriate media assets for one or more of the segments or acts of the media presentation.

User input may be received to select one of the selectable media asset icons from the plurality of selectable media asset icons for the first segment. Alternatively, or additionally, the user may provide a new media asset, and associate the new media asset with one or more of the segments in the sequence. In one embodiment, the user input may be received in response to individual forms or windows of a wizard, which may step the user through creation of the media presentation.

In a first mode, media assets corresponding to respective segments in the template may be restricted to use only in the respective segments of the media presentation. However, in a second mode, the first ordering of the segments may not be changeable by the user. Alternatively, the first ordering of the segments may not be changeable in any mode.

The method may further include viewing the media presentation and displaying the template during viewing. In some embodiments, other users may be able to modify the media presentation while viewing the media presentation using the template.

The media presentation may be provided to the user (e.g., for download, on a website, via email, etc.), where the media presentation includes the sequence of segments, and the selected media asset for the first segment. In some embodiments, providing the media presentation may include providing a pre-made media presentation which corresponds to the received user input.

Alternatively, or additionally, the method may include storing a plurality of media assets in a memory medium.

The method may further include providing a plurality of questions in a questionnaire to a user (e.g., over a network, such as the Internet). A first question of the plurality of questions may relate to a media presentation type. Alternatively, or additionally, a question may correspond to whether a specific media asset is included or excluded in the media presentation.

After providing the questions, the user may provide a plurality of answers to at least a subset of the plurality of questions (e.g., over the network).

The media presentation may then be stored based on the plurality of answers. The stored media presentation may include at least one media asset from the plurality of media assets selected based on the plurality of answers. Where the plurality of answers includes an answer corresponding to the media presentation type, storing the media presentation may include automatically generating the media presentation according to the media presentation type. Where the plurality of answers includes an answer corresponding to a specific media asset (e.g., whether to include or exclude a specific media asset), storing the media presentation may include including or excluding the media asset in the media presentation according to the answer.

Similar to above, storing the media presentation may include selecting a pre-made media presentation which corresponds to the plurality of answers.

In one embodiment, the method may further include storing a sequence of segments, where at least one media asset may correspond to each of the segments in the sequence of segments. Similar to above, media assets corresponding to respective segments may be restricted to use only in the respective segments of the media presentation. Additionally, or alternatively, storing the media presentation may include storing a document which comprises at least one reference to the at least one media asset.

After storing the media presentation, the media presentation may be displayed, e.g., for the user. The media presentation may include a sequence of segments, and a subset of the segments may be graphically illustrated on the display. In one embodiment, each of the segments may include at least one media asset icon representing a media asset and the at least two media assets may be represented by respective media asset icons.

In one embodiment, a template or wizard may be displayed after the media presentation is stored based on the plurality of answers. In other words, the user may be able to edit the media presentation after answering the questionnaire using a template or wizard. The template or wizard may be selected based on the answers.

In some embodiments, the user (or another user) may edit the automatically generated media presentation while viewing the media presentation, e.g., using a displayed template of the media presentation.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to implement an embodiment of the present invention;

FIG. 1B illustrates a network system comprising two or more computer systems that may implement an embodiment of the present invention;

FIG. 2 is a flowchart diagram illustrating a method for creating a media presentation using a template, according to an embodiment;

FIGS. 3-5 are exemplary screen shots corresponding to the method of FIG. 2, according to an embodiment;

FIGS. 6-11 illustrate further embodiments of the method of FIG. 2, according to an embodiment;

FIG. 12 is a flowchart diagram illustrating a method for creating a media presentation using a wizard, according to an embodiment;

FIGS. 13-19 are exemplary screen shots corresponding to the method of FIG. 12, according to an embodiment;

FIG. 20 is a flowchart diagram illustrating a method for creating a media presentation using a questionnaire, according to an embodiment;

FIGS. 21-42 are exemplary screen shots corresponding to the method of FIG. 20; and

FIGS. 43-48 are further embodiments which incorporate the methods of FIGS. 2, 12, and 20.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network and/or other physical transmission medium, that conveys signals such as electrical, electromagnetic, or digital signals.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Act—one of the major divisions (in time) of a media presentation. Each act may have a conceptual role or narrative purpose as defined below.

Conceptual role—The role played by an element, such as narration or musical score, as opposed to narrative purpose or media type.

Narrative purpose—the narrative or dramatic purpose of an act or series of acts. The narrative purpose of a series of acts may fulfill another narrative purpose. For example, the narrative purpose of act I may be “an introduction” and the narrative purpose of the entire series of acts which make up a production may be “get people to use less air conditioning”. A narrative purpose may also be more abstract, such as being a media content type.

Media Asset—a piece of multimedia from which a media production can be composed, such as an image, song, or video segment.

Placeholders—media which is placed in each of the available segments and either conforms to the conceptual role and narrative purpose or instructs the user on the conceptual role and narrative purpose of the slot.

Media Presentation Type—Refers to the form and abstract purpose of a production, such as public service announcement or love story.

Production—One act or a series of acts which are linked together linearly to form a relatively continuous media piece.

Segment—An act or portion of an act which contains or is associated with a media asset.

Template—A data structure containing all of the necessary information for the creation of a production of a production type specified in the template. The template may include the narrative purpose of each act, the narrative purpose of the entire production, and the conceptual role of each track.

Timeline—usually a track (see below) on which media elements are sequentially composed.

Track—a linear collection of one or more media elements. Usually several track are merged in parallel time to make a production. A track may be limited in duration to one or more acts.

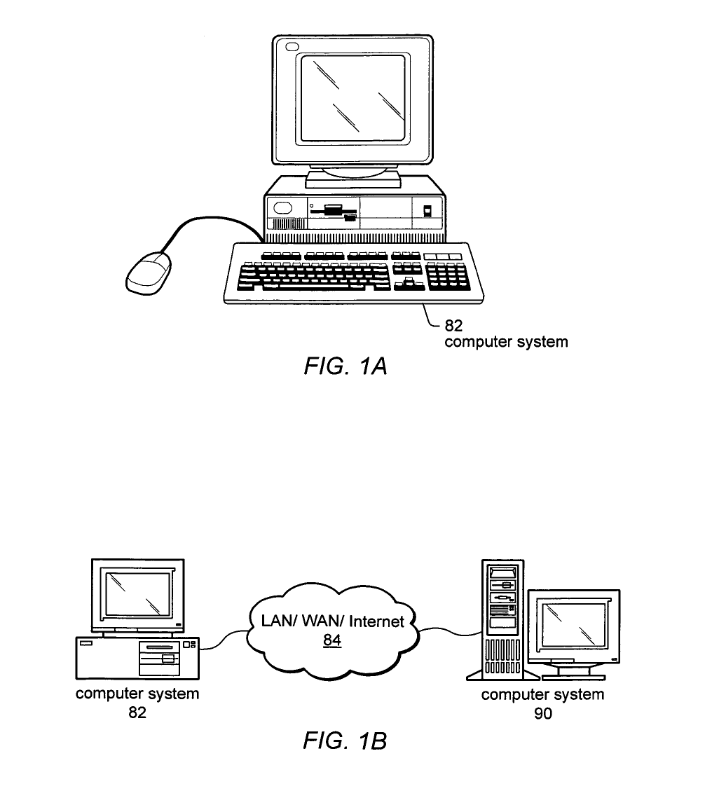

### FIG. 1A—Computer System

FIG. 1A illustrates a computer system 82 operable to execute various software stored in memory mediums according to embodiments described herein.

As shown in FIG. 1A, the computer system 82 may include a display device operable to display a user interface, e.g., as a media presentation is created and/or presented. The display device may also be operable to display a template of the media presentation during creation and/or presentation of the media presentation. The graphical user interface may comprise any type of graphical user interface, e.g., depending on the computing platform.

The computer system 82 may include at least one memory medium on which one or more computer programs or software components, according to one embodiment of the present invention, may be stored. For example, the memory medium may store one or more media creation tools which are executable to perform the methods described herein. Additionally, or alternatively, the memory medium may store a network or Internet browser which may access webserver(s). The user may be able to create media presentations using the browser and/or applications served by the webservers described in more detail below. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute media creation tools in a distributed fashion. For example, computer 82 may execute a first portion of the media creation tool (e.g., in a browser executing on the computer system 82) and computer system 90 may execute a second portion of the media creation tool (e.g., server side portions of the media creation tool). The computer system 90 may be a server and/or another client computer, as desired.

As indicated above, in some embodiments, the computer system 90 may be replaced with one or more web servers, storage servers, and/or other computer systems which are operable to assist a user in creating a media presentation. In one embodiment, the servers may store web applications which are served to the computer system 82 and which a user may use to create the media presentation. After completion, the servers may store the completed presentation.

### Following Descriptions

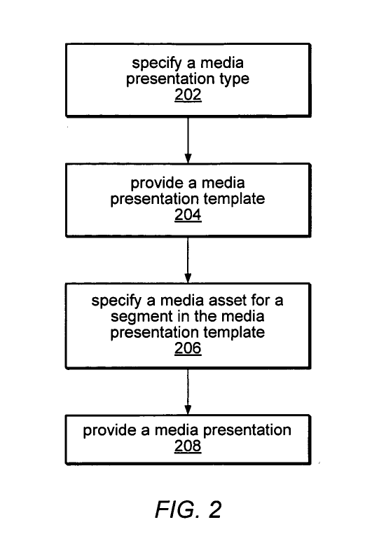

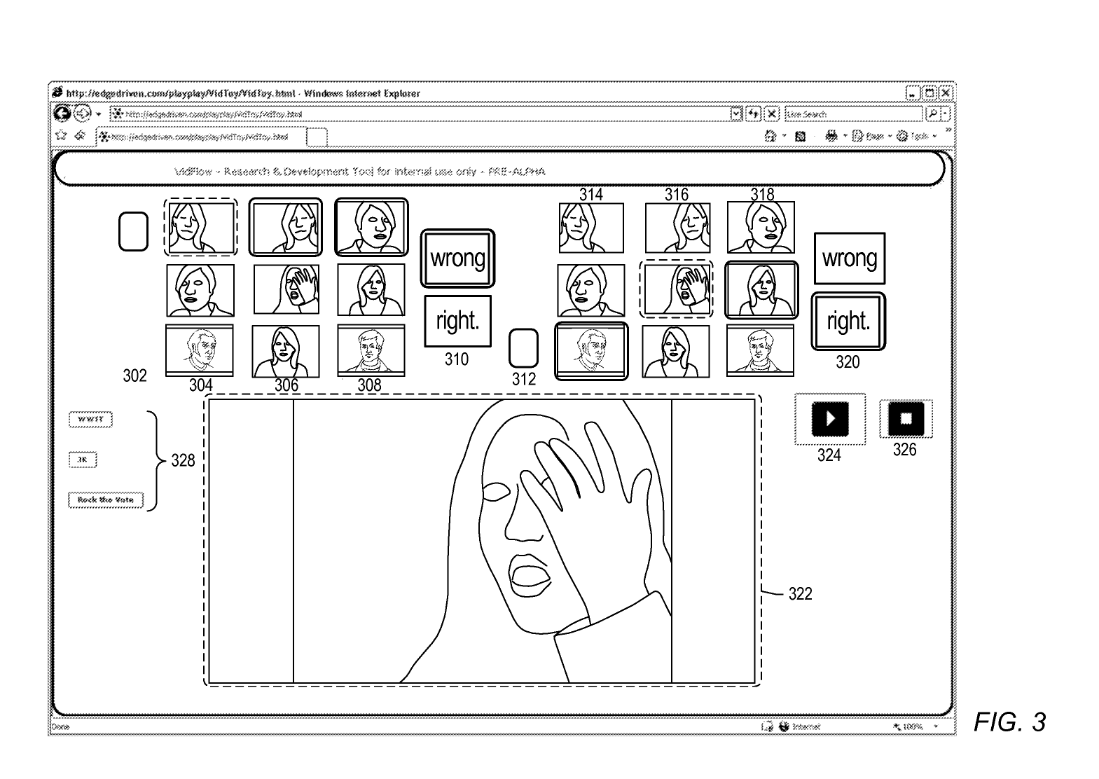

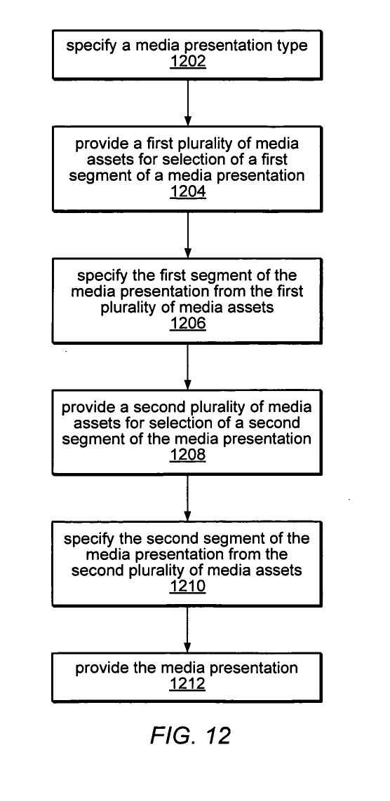

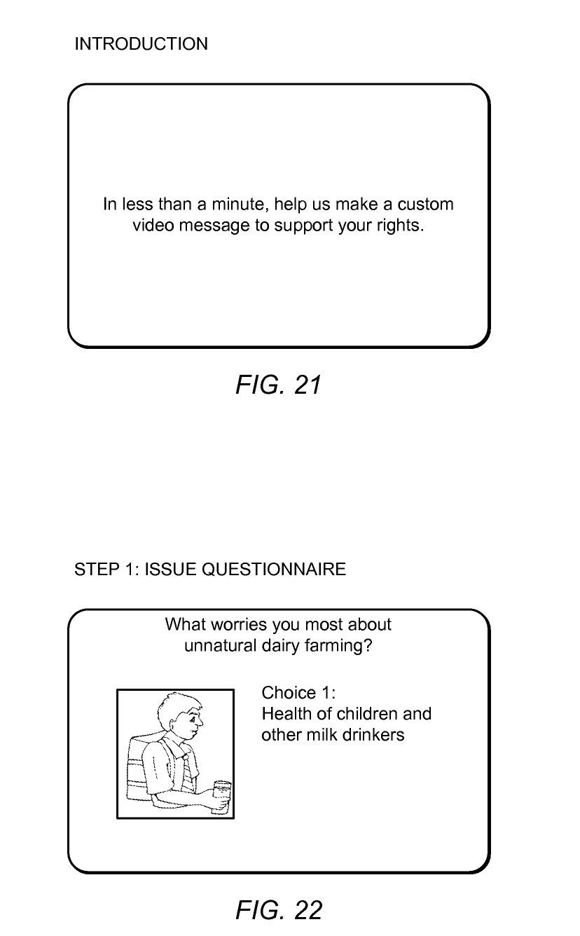

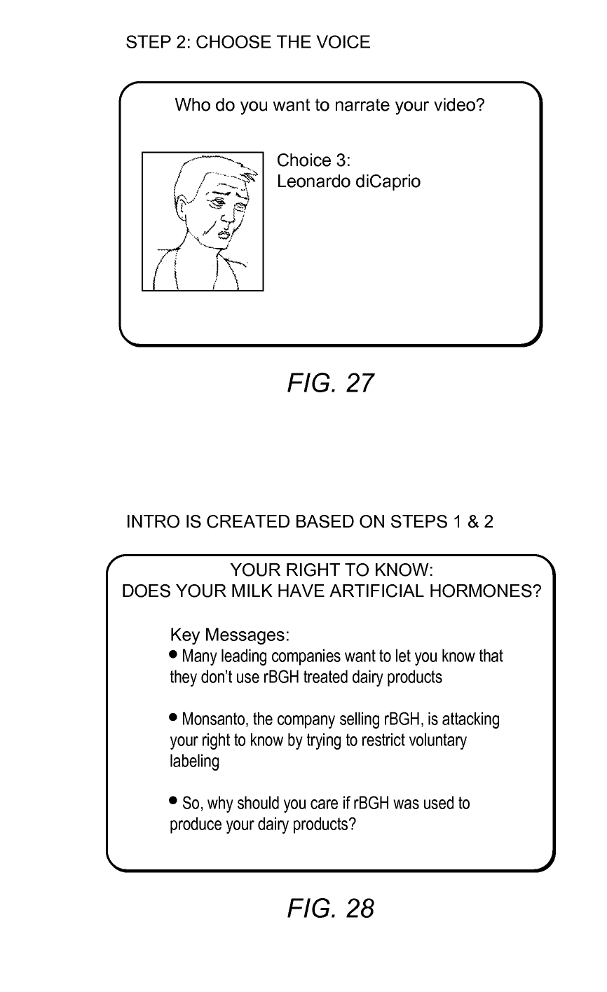

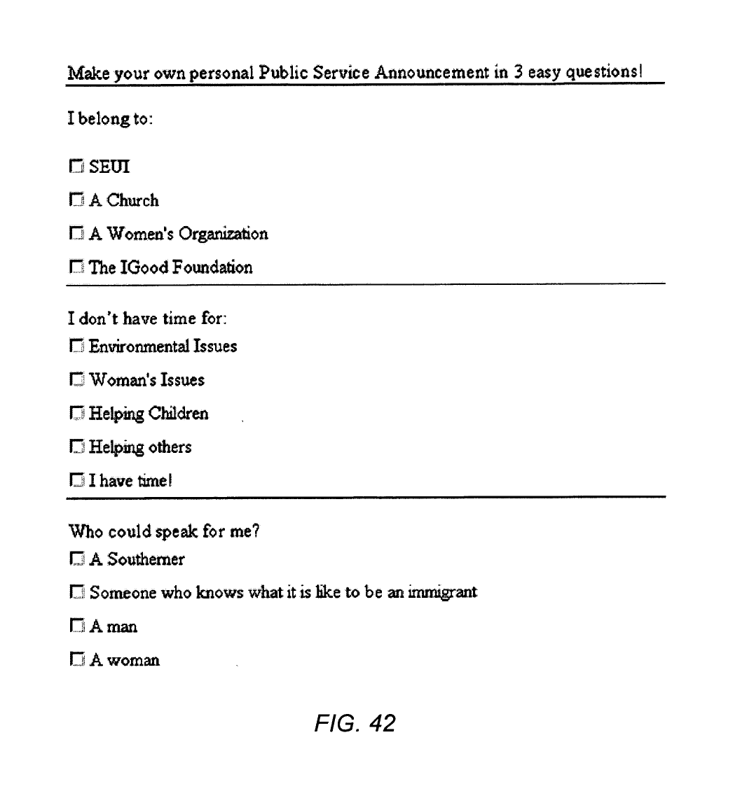

In the subsequent sections, FIGS. 2-11 correspond to an exemplary method for creating a media presentation using a template, FIGS. 12-19 correspond to a method for creating a media presentation using a wizard, and FIGS. 21-42 correspond to a method for creating a media presentation using a questionnaire.

### FIG. 2—Flowchart

FIG. 2 illustrates a method for creating a media presentation using a template. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 202, a user may specify a media presentation type, e.g., using a media application tool or program. In one embodiment, the user may specify the media presentation type by selecting a media presentation type from a list of available types displayed on a display. Alternatively, the user may specify the presentation type using an input device to a computer, e.g., a keyboard, mouse, touch screen, etc., to specify the media presentation type. As used herein, “media presentation type” refers to a category or class of media presentation which the user wishes to create. For example, for video presentations, a media presentation type may be a newscast, commercial, activist campaign, movie of various genres, short film, etc. Similarly, for audio presentations, the media presentation type may refer to various other types such as music of a genre (e.g., jazz, RnB, pop, country, rock, etc.) or conforming to a specific form (e.g., AABA). However, audio presentations are not limited to music, but may also be for audio books, speeches, radio advertisements, etc. In some embodiments, where the media presentation type is textual, the media presentation type may refer to short stories, children stories, fables, novels, novellas, etc. Additionally, where the media presentation type includes graphics, the media presentation type may be a slideshow, an art exposition, a pictorial short story, etc.

Note that the user may also be able to further specify the media presentation type using subcategories of those described above. For example, if the user has selected a newscast, he may then select a specific type of story in the newscast as the media presentation type, e.g., a dramatic newscast or an uplifting newscast, etc. Similarly, if the user selects or specifies an advertisement, he may be able to select or specify a more specific advertisement media presentation type, e.g., personal story, comedic, celebrity endorsement, expert testimonial, comparison, infomercial, fake newscast, scapegoat, scare campaign, bandwagon, etc.

In some embodiments, the user may select the media presentation type by selecting options through a wizard which guides the user in making the selection. For example, a first window or portion a wizard (e.g., in the form of a graphical user interface (GUI)) may allow the user to specify a general category and then later windows or portions may allow for full specifying the media presentation type desired by the user. However, in one embodiment, the user may simply select or specify the specific media presentation type immediately.

Alternatively, or additionally, the user may select or specify the media presentation type by opening a web page over the Internet using a web browser executing on the user's computer. The web page may include one or more exemplary media presentations corresponding to different topics or types, and by selecting one of these media presentations, a media presentation type or template may be specified. Similar to above, the web page may simply list one or more media presentation types for selection or allow the user to specify the media presentation type using other methods, as desired.

Thus, according to various embodiments, the user may be able to choose or specify a type for the media presentation.

In 204, a media presentation template may be provided/displayed. The media presentation template may be displayed in response to receiving user input specifying the media presentation type in 202. More specifically, in one embodiment, the media presentation template may be a template which corresponds to the media presentation type specified by the user. For example, where the user specifies an advertising campaign, e.g., a comparison advertisement, the template may correspond to the comparison advertisement. In this case, the template may include a series of acts (possibly including segments) including, for example, introduction of the product, introduction of the competitor's product, comparison, and conclusion. In some embodiments, there may be a one-to-one relationship between media presentation types and media presentation templates; however, other relationships are envisioned where many media presentation types may be mapped to a single template (e.g., those types which have similar act or segment sequences).

As another example, the user may specify a PSA (public service announcement), that may be divided into Get Their Attention, Why It Matters, What You Can Do, etc. Acts. The PSA could be used for voter registration, stop global warming, stop abuse, etc.

However, it should be noted that the media presentation template may be displayed without requiring that the user specify a media presentation type in 202, as desired. For example, in some embodiments, only a single media presentation type may be available, or the user may simply open an existing media presentation template. As used herein, the term “template” is intended to include already existing media presentations which exemplify a desired media presentation (or media presentation type), or a form which the user can use to create a desired media presentation.

As indicated above, the media presentation template may include a sequence of acts and/or segments. An act may correspond to a portion of media presentation type or template. For example, in the advertising type described above (comparison), the first act may be the introduction of a product, the second act may be the introduction of the competitor's product, the third act may be the comparison, and the final act may be the conclusion. Each act may contain one or more segments. For example, two segments may be associated with the product comparison (e.g., two customers may present different stories in the two segments). Each segment may have or be associated with one or more media assets. As used herein, “media asset” refers to a data file stored in memory which includes information which is interpretable to present media (e.g., audio, movie, animation, single graphics, text, etc.). The media asset may be a media filed in any of various formats, e.g., mpeg, avi, jpg, pic, png, ogg, mp3, txt, doc, pdf, ppt, etc.

However, it should be noted that some media assets may be associated with more than one segment. For example, a narration media asset may be associated with all or a subset of the segments (or at least more than one of the segments). In another example, sponsorship overlays (e.g., graphics which may be placed, possibly transparently or semi-transparently, on the media presentation which correspond to a sponsor) may be associated with more than one segment. Thus, some media assets may span more than one segment, as desired. Additionally, some segments of the media presentation template may not have associated media assets. In other words, only a subset of the segments may have or be associated with a media asset (e.g., represented by a media asset icon).

The segments may be indicated (e.g., graphically illustrated) on the display in the template. For example, the segments and/or acts may be displayed (e.g., in a first ordering) in the template on the display in a left-to-right or top-to-bottom fashion. The segments or acts may be indicated on the display via a variety of methods. For example, in one embodiment, the segments may be graphically indicated, e.g., by graphics or media asset icons which are described in more detail below. Alternatively, or additionally, each of the segments may be indicated via text, e.g., titles of the segments or acts on the display. Thus, the user may be aware of the segments and/or titles in the media creation template.

In some embodiments, each of the segments may have a default or placeholder media asset associated with the segment. The placeholder media asset may be an exemplary asset which the user may replace with another media asset that fills the same purpose in the media presentation. Following the comparison advertisement example from above, a first placeholder asset for the first segment may be a person introducing a generic product (e.g., one that is not associated with the product the user wishes to describe) so that the user can understand what type of media asset should be placed in the first segment. In other words, the placeholder asset may provide or indicate a purpose for the segment with which it is associated, thereby allowing the user to understand what media asset(s) should be associated with that portion of the media presentation.

The media asset may be represented as a media asset icon in the segment, thereby indicating to the user that the media asset is associated with the segment. The media asset icon may be a thumbnail image which indicates the content of the media asset (e.g., a first or representative frame of a video asset, or a small image corresponding to a graphic). The media asset icons may otherwise graphically indicate content of the media asset. For example, in one embodiment, the media asset icon may have a picture of a man or a woman, indicating (among numerous other possibilities) that the video includes a man or woman respectively, the narration is performed by a man or woman, that the content regards a man or a woman. Thus, the media asset may be represented on the display by a media asset icon. Note that other methods for representing the media assets are envisioned, e.g., displaying text for each media asset, or methods other than icons.

In 206, the user may be able to select or specify a media asset for a segment in the media presentation template. In some embodiments, a plurality of media assets may be associated with a segment in the media presentation template. For example, the media presentation template may include a first segment where only a single media asset may be used, a second segment where the user may select from one of two media assets for that segment, a third segment where the user may select from three media assets, and a final (e.g., conclusion) segment where the user cannot choose among media assets. In these embodiments, the user may select among the possible media assets for segments which have more than one option (in this case the second and third segments).

For example, in one embodiment, the sequence of segments/acts may be graphically indicated by a plurality of media asset icons, e.g., in a left-to-right fashion. Where the user can choose among a plurality of assets for a particular segment, more than one media asset icon may be displayed in a top-to-bottom fashion, as one example. Thus, for a given media presentation template, the user may make choices among the displayed top-to-bottom media assets for each segment that includes or is associated with more than one media asset icon. In one embodiment, the user may select these media assets by clicking the media asset icons with a mouse or other user interface device, as desired. Note that this method of displaying options is exemplary only, and that other methods are envisioned. For example, the user may specify the different media segments by selecting them from a drop down box for each different segment, among other methods.

Alternatively or additionally, different types of media assets may be indicated (e.g., with media asset icons) for each segment in the sequence of segments of the media presentation template. For example, as indicated above, a segment may include or be associated with one or more types of media assets (e.g., audio, video, text, graphics, etc.). In such cases, the media assets may be displayed as media asset icons on the display and graphically indicated as associated with a particular segment (e.g., in the top-to-bottom orientation described above, as one example among many options). For example, a first segment in the media presentation template may be associated with a plurality of video media assets, a plurality of narration assets, a plurality of music assets, and/or a plurality of text assets (among others). In this example, the user may choose a single media asset for the video, a single audio asset for the narration, a single media asset for background music, and a set of text assets for labeling or translation.

Note that as used herein “first” may or may not be related to sequential ordering. For example, the first segment above may be the first in the sequence of segments or may simply be one of the segments in the template. Similar descriptions apply to other numerical labels, which may be used to indicate ordering or simply to distinguish among the other similarly labeled items.

Alternatively, or additionally, the user may be able to browse for different media assets for segments or provide outside content (e.g., user made) for various ones of the segments. For example, where the media presentation template indicates to the user the purpose of each of the segments (e.g., with exemplary media assets or with text), the user may be able to upload media assets which fit that purpose. Various dialogs or interfaces may be used for providing the content, including, among other examples, a file browser for locating the file, an upload screen (e.g., on the website), an option to record a new media asset (e.g., using a video camera of the computer system), etc. Note that the user may be able to specify outside media assets even when a plurality of media assets are available for selection for a given segment. However, in some embodiments, the user adding content may not be allowed during creation of the media presentation (e.g., according to different modes of operation).

In some embodiments, selection of a particular media asset for a segment may result in the selection of a different media asset. In other words, some of the media assets may be linked or anti-linked. For example, if a user selects a certain audio asset for narration, the corresponding text media for the narration may also be selected. Alternatively, or additionally, the linkage may be over separate segments, as desired. In one example, the user may select a first media asset for an introductory segment, and a corresponding conclusion may be automatically selected (or vice versa). As indicated above, there may also be anti-linkages where if a user selects a certain media asset, another media asset is unselected and/or removed from the available media assets for selection. For example, if a user selects a media asset which expresses a first view (e.g., in an activism media presentation), other media assets which express opposite or unrelated views may be automatically unselected or removed. These linkages or anti-linkages may be defined in the media asset template.

Similarly, media asset selection may be dynamic in nature, where the nature of the media presentation is formed and changed as the user makes media asset selections. In one embodiment, the user may be limited to making media asset selections from the beginning of the media presentation to the end of the media presentation, and each choice may affect future available options in the coming choices for the media presentation. Thus, selection of media assets may be dynamic in nature, as desired.

Additionally, the media presentation template may include a first portion which allows the user to view and/or listen to the selected media asset. For example, when the user selects one of the media assets (e.g., via the corresponding media asset icon on the display), the media asset may be presented for viewing and/or listening in the first portion of the media presentation player. In one embodiment, the first portion of the media presentation template may include one or more controls, such as, for example, volume control, a slider for moving along the timeline of the media asset, a rewind and fast forward control, and/or other controls for manipulating presentation of the media asset(s).

In a first mode (e.g., a simple or beginner mode), the first ordering of the sequence of segments may not be changed by the user, e.g., in order to simplify the process for the user and provide for an easy and efficient manner to produce a quality media presentation. However, in some embodiments, e.g., in a second mode, such as an advanced mode, the user may be able to rearrange different sections of the media presentation template or the media presentation itself. In some embodiments, the user may not be able to change the first ordering in any mode.

Alternatively, or additionally, the first mode may not allow the user to rearrange media assets from one segment to another. In other words, the media assets corresponding to respective segments of the media presentation may be restricted for use only in those specific sections. For example, an introductory media asset may only be usable in the first introductory segment of the media presentation. Note that there may be situations where a media asset may be available in multiple sections, but may not be moved from those sections. For example, a given media asset may be appropriate for any of the middle segments regarding a topic, but the user may not be able to rearrange that media asset to be the introductory or conclusory segment, as one example. However, in a second or advanced mode, the user may be able to move media assets from one segment to another.

In some embodiments, the user may be able to select a preview option (e.g., a play button) which allows the user to pre-view what the final media presentation will look like (e.g., the entire media presentation or portions of the media presentation). The user may use this tool as for editing purpose (e.g., to identify the strength of transitions, where sounds or narration may need to change, etc.).

Finally, in 208, the media presentation may be created and/or provided. The media presentation may include all of the media assets selected by the user as well as default or placeholder media assets which the user did not (or could not) change.

In some embodiments, further segments, which were not displayed in the template may be added to the media presentation. In other words, the plurality of segments initially displayed in the media presentation template may not be the only segments associated with the media presentation. For example, a media asset may be inserted which introduces or concludes the media presentation (e.g., a sponsor's advertisement or note), or a sponsor's graphic may be overlaid for a portion or the entirety of the presentation. In another embodiment, the sponsor's message, graphic, video clip, or other media, may be inserted in the middle of the media presentation, as desired. Other segments which were not displayed in the media template are envisioned.

In some embodiments, the media presentation may be created or provided as a media file (e.g., in the various formats described above, among others). Thus, the final media presentation could be an mpeg or avi file (among others) if the media presentation is a video presentation. The file may then be provided to the user over a network for display, possibly allowing the user to distribute the file (if the actual file is provided) or just for viewing (e.g., if streamed to the user). In some embodiments, all of the possible combinations of the provided media assets (for each segment) may be pre-made. Thus, providing the media presentation to the user may simply include determining which pre-made media presentation corresponds to the selections made by the user. However, this may not be possible for all situations (e.g., where the user provides his own content or the possible combinations reach numbers higher than the space required warrants).

In some embodiments, instead of creating a media file, the method may include creation of a file which indicates the segments (e.g., points to the various segments that are already stored, e.g., on the webserver) that are included in the media presentation. For example, the file could be an XML (eXtensible Markup Language) file which indicates the locations of each of the segments of the media presentation. In these embodiments, the server may simply store all of the segments in individual locations, and each generated media presentation may be stored as an XML file. Accordingly, when the media presentation is provided for display (e.g., streamed from the web server), the media server may simply provide each segment in series in a manner in which a viewer could not tell that the media presentation was not a single media file. Thus, instead of consuming valuable server space with redundant media files, the media presentation may be a file which indicates each of the media assets (or other files) of the media presentation.

The method may further include allowing the user to share the video, or providing a universal resource identifier (URI) link, such as a universal resource locator (URL). For example, the user may be able to enter one or more addresses (e.g., email addresses) which may allow the user to share the created video with other users or companies.

Furthermore, in one embodiment, the user may be able to view the presentation and see the media presentation in a form similar to the media presentation template. In other words, the user may view the media presentation in a format which is similar to the editing environment of the media presentation. In this case, when viewing the presentation, the user may be able to rearrange or change the presentation as it is playing or in order to create a derivative of the media presentation.

Thus, FIG. 2 illustrates an exemplary method for creation of a media presentation using a media presentation template.

### FIGS. 3-5—Exemplary Screenshots of the Method of FIG. 2

FIGS. 3-5 are exemplary screenshots of a method for creating a media presentation corresponding to the method described in FIG. 2.

More specifically, FIG. 3 is an exemplary media creation template where the user can create a media presentation. As shown, the user may select from a plurality of music tracks 302 (shown as media asset icons representing media players) for the first three segments of the video presentation 304, 306, and 308, select from three different video assets for each of the first segments 304, 306, and 308 (in this case, each video asset corresponds to different people providing their thoughts), select from two video assets for “wrong” or “right” 316, select from one of the four music assets 312 for music background in the final section, select specific assets for the following three segments 314, 316, and 318, and select a final video asset for “wrong” or “right” 320 to conclude the media presentation. As also shown, the template may include a stop and play button 326 and 324 respectively, a video preview section 322 (where the user can preview individual assets, e.g., when they are clicked, or the entire media presentation), and a selection tool 328 for selecting among different media presentation templates.

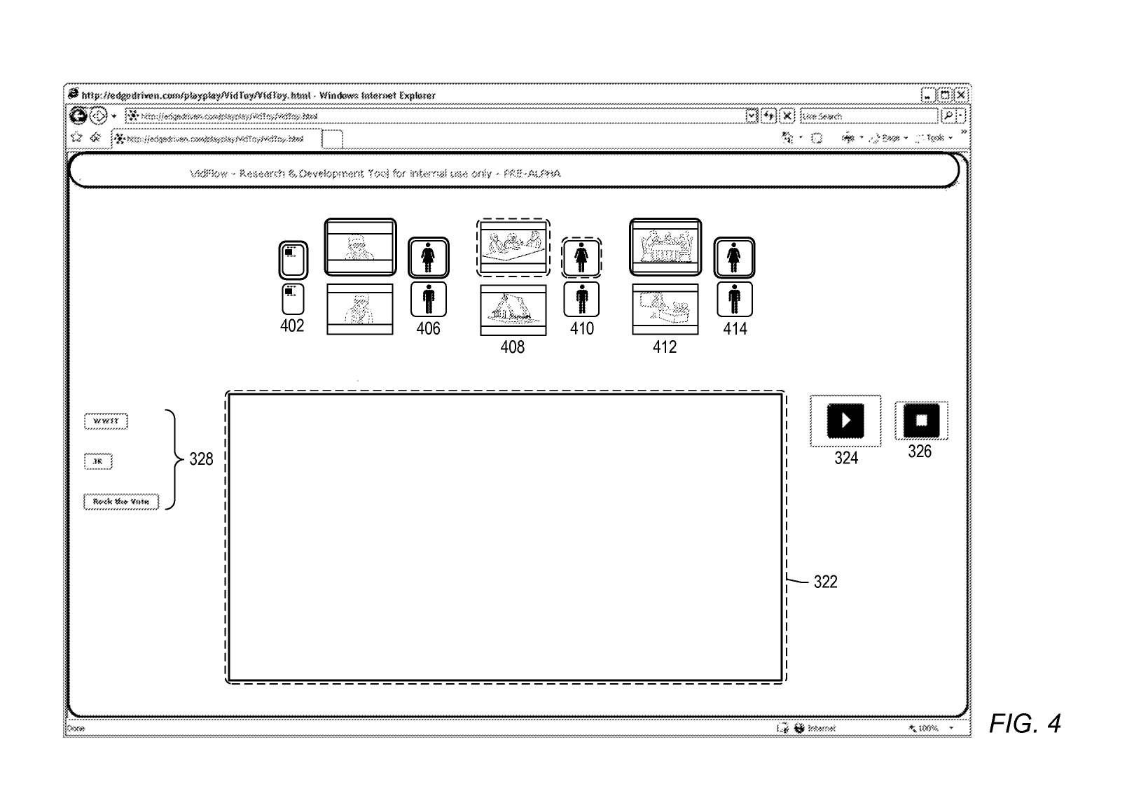

Similarly, in FIG. 4, the user may select one of two background music assets using media asset icons 402 on the left for the entirety of the media presentation. For the first segment, the user may select a video asset (of two) 404 and select a male or female narrator asset 406. The user may make similar choices for the final two segments, using media asset icons (for video assets) 408 and 412 and media asset icons (for narration) 410 and 414. Similar to above, the media template of FIG. 4 includes a stop and play button 326 and 624, a media presentation preview 322, and a selection tool 328 for selecting among different media presentation templates.

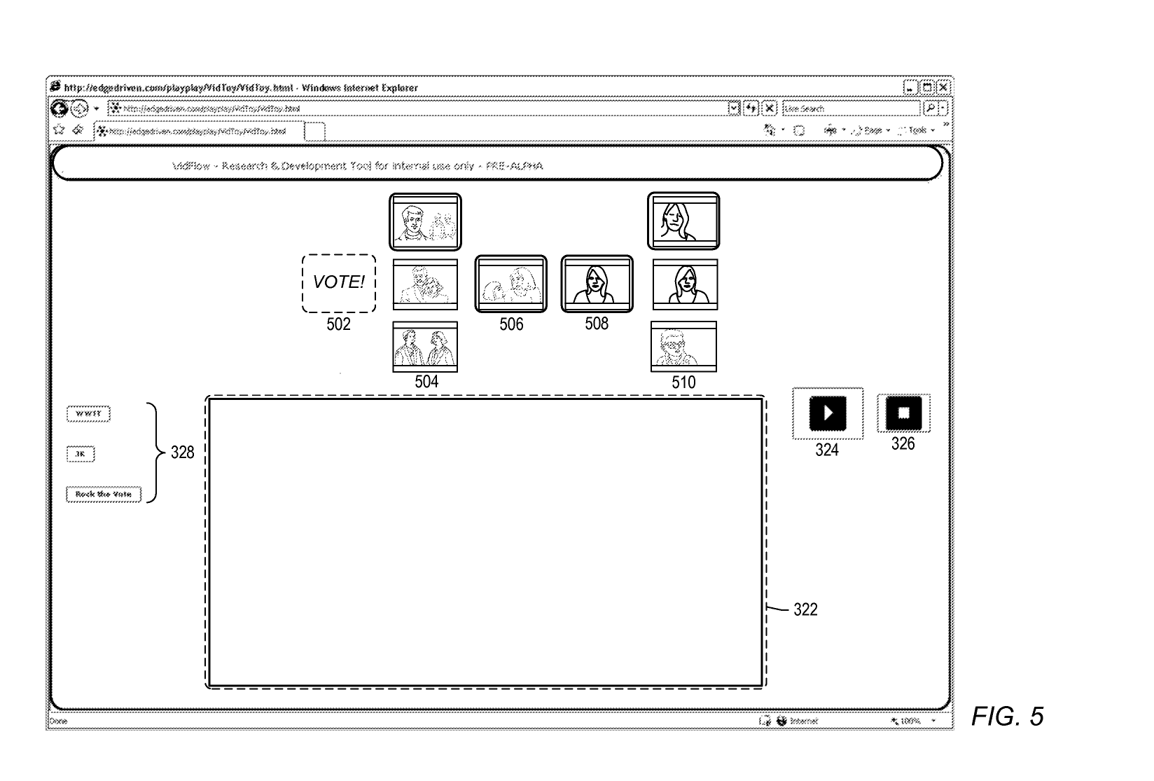

Finally, in FIG. 5, the user may make only two choices, selecting one of the three video assets for the second segment 504, and selecting one of the three video assets for the final segment 510 using the media asset icons shown. Segments 502, 506, and 508 have only one media asset available, and therefore are not user selectable. The media template of FIG. 5 also includes the further portions already described above.

### Further Embodiments for Creating a Media Presentation Using a Template

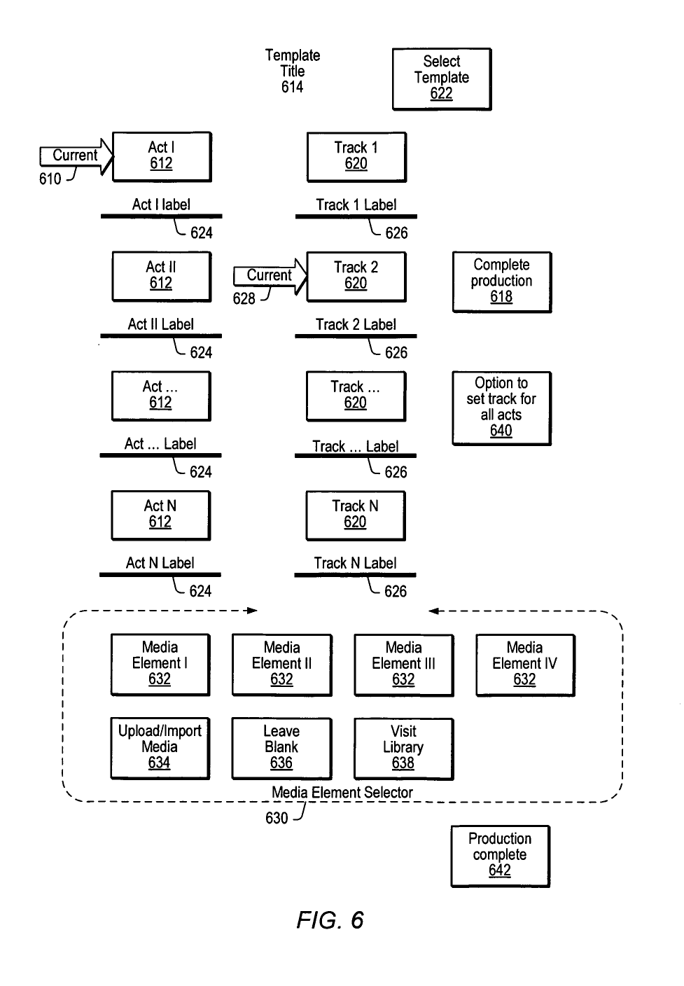

FIGS. 6-11 are further embodiments of a method for creating a media presentation using a template. Note that these embodiments are not intended to limit the scope of any of the descriptions above, e.g., regarding FIGS. 2-5.

FIG. 6 is an interface summary view of an example of a single page implementation of a template for creating a media presentation.

The title of current screen 614 may give the user a one line title for the production being created, this title may indicate the media presentation type which is being produced, such as “short public service announcements”. In FIG. 6, the application may allow the user to select from a variety of templates from the production template selection interface 622. As one example, if the application is usable to help the user create public service announcements, it may only provide the public service announcement template. The interface displayed in FIG. 6 is for a template with a four act production, Act I having four tracks. Tracks 3 and 4 allow the user to load content into those tracks which is used across all of the Acts (e.g., using option to set track for all acts 640).

In the example in FIG. 6, default content may be placed in each of the tracks and acts used in the current production template. Since there are default placeholders for one or more tracks 620 as well as placeholders for one or more acts 612, there is a complete production to view from the beginning of the production process. From time to time, the user may want to play the preview of the complete production 618 in order to see how the entire production looks with their current selections.

The production of FIG. 6 is made up of a set of one or more acts 612. The current act indicator 610 tells the user which act is currently being modified. The user can select the preview of the current act to see the current composition for the act, or select a different act to manipulate. As a default, the placeholder for one or more acts is set for the act and in the preview of the act. A template specific act label set may help to guide the user in creating content which achieves the goals of the current production template.

An act may be composed of a set of one or more tracks 620. An act may or may not contain the same number of tracks. The current track indicator 628 tells the user which track is currently being manipulated. The user may select to preview of the track to view the currently selected track within an act, or across all acts. In some embodiments, the user may be able to change the tracks within each act, in other situations the user may be selecting a track to use across all the acts, such as a narration which will be used across all of the acts and guide their other creative choices. The default for the option to set track for all acts 640 is OFF. Depending on the template used, the option to set track for all acts 640 may be set to ON for one or more tracks by the application and may or may not be alterable by the user. The selection of media elements which provide content across all of the acts may determine the setting for this option as well. A template specific track label set may guide the user in achieving the goals of the current production template while manipulating the track content.

The core of the user creation and creativity takes place within the media element selection interface 630. Here the user can select from a small list of media provided through the application via the provided media element selection options 632. The user may add other content for use in the production via the upload element option 634. In some situations, they user may be allowed to leave a track, act, or combination thereof blank by using the option to leave element blank 636. Additional media elements may be accessed via the option to visit media library 638.

When the user is done with his creative work, or wishes to save it for later work, he may use the production complete button 642 to tell the application to publish or save the current workspace. The media presentation may created or provided according to the embodiments described above in FIG. 2.

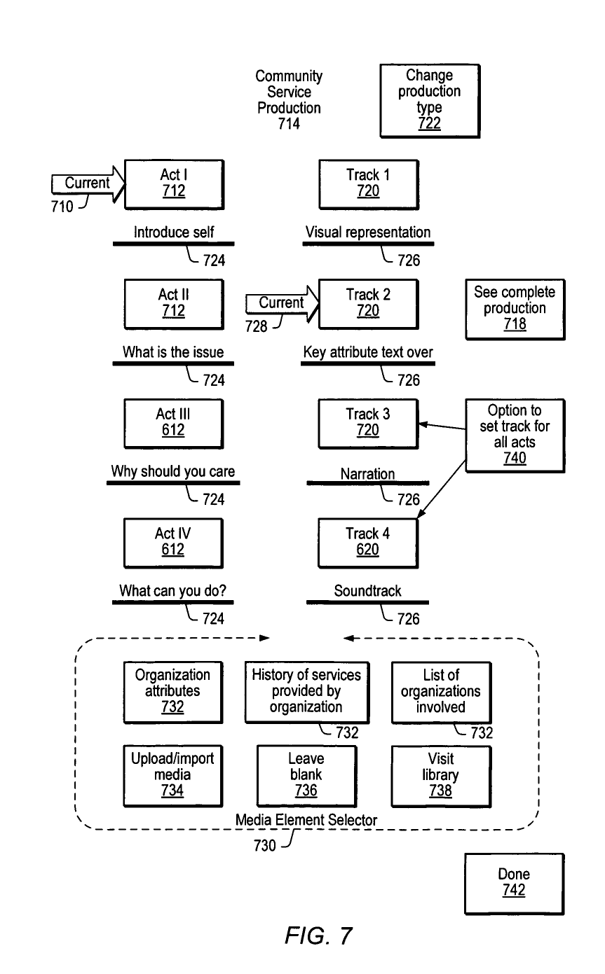

FIG. 7 is an example interface view of another embodiment. In FIG. 7, an interface is displayed which has a production template loaded for creating Community Service Productions (Community Service Announcements) as indicated in 714. The production template selection interface 722 is there to allow the user to select a different production template. The user is currently editing Act I, according to the current act indicator 710, the purpose of which is to “Introduce self” according to the label from the template specific narrative act label set 724. The user is manipulating track number 2, according to the current track indicator 728, the purpose of which is to provide a text over of key attribute of the community organization publishing the announcements, according to the label from the template specific narrative track label set 726.

The media element selection interface 730 displays the media elements available to the user for the current location, as well as allows them to leave the location blank, import their own media elements or access a library of elements.

FIG. 8 is an example interface view of an embodiment of a potential single track implementation. In FIG. 8, a template has been loaded for the creation of a romance story. There is only one track for Act I, “Boy meets girl”, so the track specific elements are not necessary. The production template selection interface 722 element has been removed, and the user is not allowed to select another production template. As shown, the acts 812 are still indicated with corresponding titles, the purposes of the acts are identified by 824, and the user may still select from different media assets, upload or import other media assets, or browse the media library in media element selector 830. The user may view the complete production in 818 or complete production in 842.

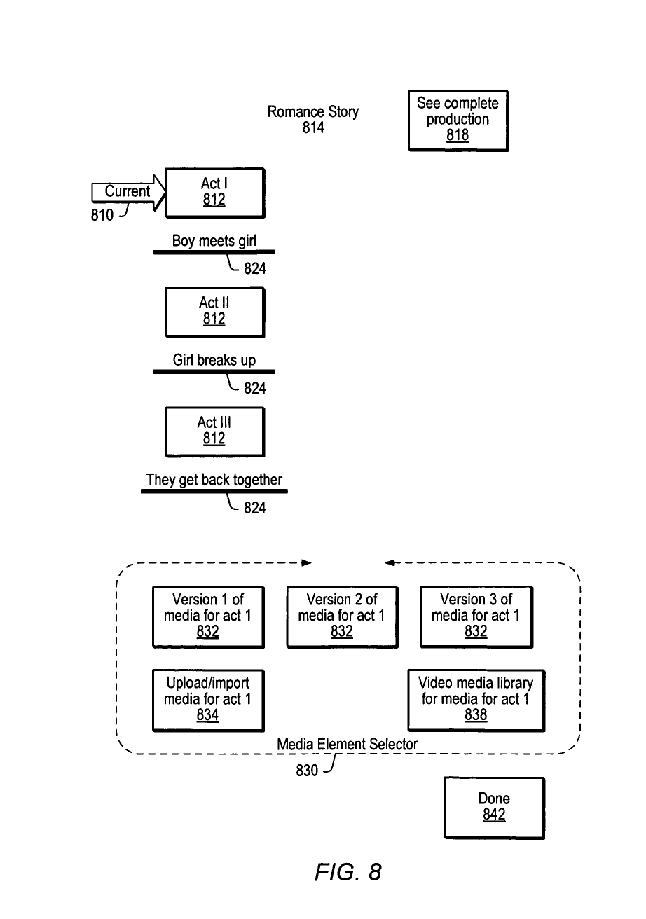

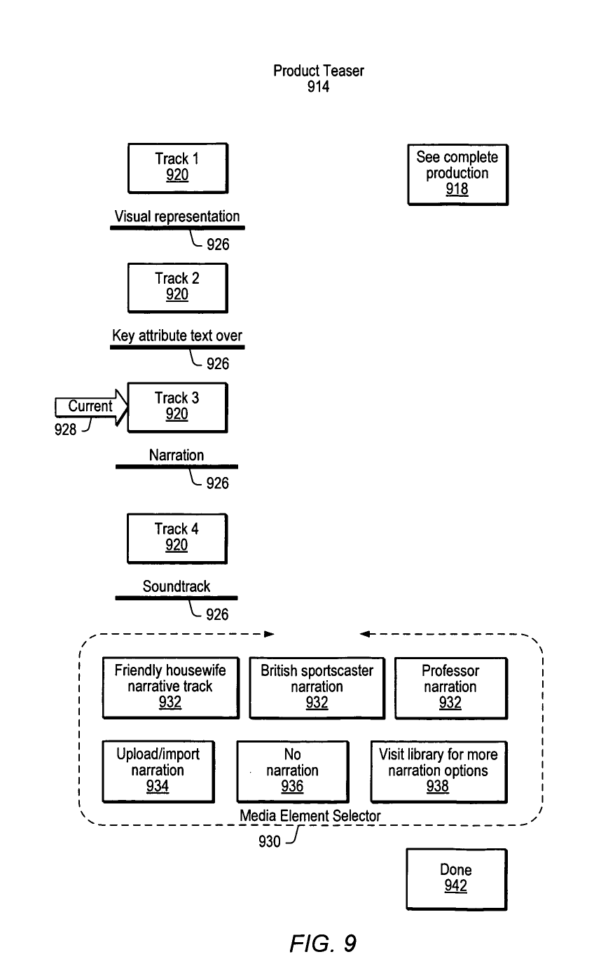

FIG. 9 is an example interface view of a potential single act in a media presentation. In FIG. 9, a template has been loaded for creating a product teaser as indicated in 914. There is only one act, with several tracks, so the act specific elements are unnecessary and have been removed. FIG. 9 includes tracks 920, labels 926, complete production 918, media element selector panel 930, and completion interface 942 similar to those described above.

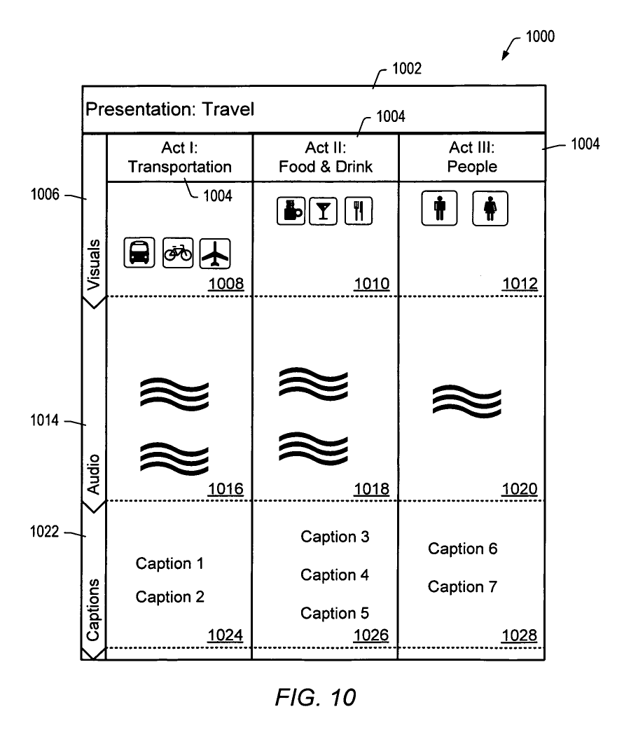

FIG. 10 is an exemplary media presentation template according to some embodiments. As shown, the media presentation template may include a title 1002 (“Presentation: Travel), a top section 1006 for visuals, a middle section 1000 for audio, and a text section 1022 for captions, among other possibilities. In vertical segments, the acts 1004 (Act I: Transportation, Act II: Food & Drink, and Act III: People) are displayed. The first act is devoted to Transportation with video asset 1008, audio assets 1016, and captions 1024; the second act is devoted to Food and Drink with video assets 1010, audio assets 1018, and captions 1026; the third act is devoted to people with video assets 1012, audio assets 1020, and captions 1028. As shown, the user may select from the different options in each different act and media asset type.

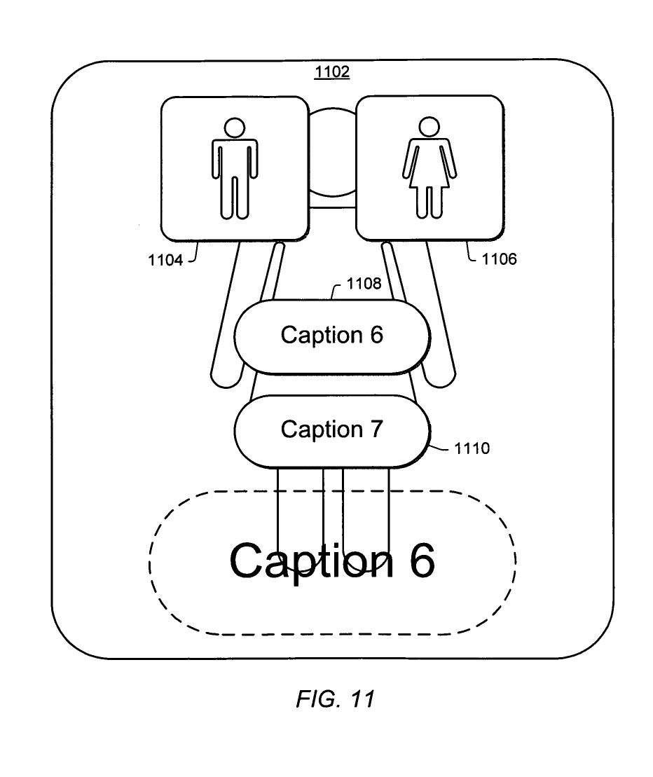

FIG. 11 is an exemplary asset selection screen 1102 according to some embodiments. As shown, the user may select between a male or female narration asset (as indicated by the male and female icons 1104 and 1106) and may choose between caption 6 or caption 7 using icons 1108 and 1110.

### FIG. 12—Exemplary Method for Creating a Media Presentation Using a Wizard

FIG. 12 illustrates a method for creating a media presentation using a wizard. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 1202, a user may specify a media presentation type, e.g., as described above in 202 of FIG. 2.

In 1204, a first plurality of media assets may be provided for selection of a first segment of a media presentation. Similar to above, the media assets may be provided for selection according to various methods. For example, the user may access a webpage or website to create the media presentation, and accordingly, the media assets may be provided for selection in a browser window executing on the user's local computer (although portions of the media creation will be executing on the web server as well). Alternatively, the media creation program may execute locally on the user's computer system; however, in some embodiments, this application may perform one or more communications over a network, e.g., to web servers or servers storing media files, etc.

Where the user has specified a media presentation type, the first plurality of media assets may correspond to the media presentation type. More specifically, the media presentation which the user is creating in the methods described herein may correspond to the specific media presentation type chosen in 1202. However, where the user has not selected a media presentation type, the user may simply begin with 1204.

The first plurality of media assets may be displayed on a display for selection. For example, the first plurality of media assets may be displayed on the screen using media asset icons which visually represent the media assets. Alternatively, or additionally, the plurality of media assets may be presented in a file browser window (e.g., for selecting and/or uploading files located on a server or local computer). Other methods for displaying or indicating (e.g., graphically) the possible media assets are envisioned, such as those described above (e.g., regarding FIG. 2), among others.

In some embodiments, the media assets may be displayed in a first window of a wizard which guides the user through a process of creation of media presentation. In particular, the first window of the wizard may allow the user to select the first user-selectable media asset for a segment in the media presentation. However, it should be noted that the first window does not necessarily correspond to the first segment in the time-sequence of segments. For example, in one embodiment, the first selection or window may be used to select a conclusion, or may be the second segment of the media presentation (e.g., if the introduction or first segment in the time sequence is already selected).

The first window or selection screen for the plurality of media assets may include a preview screen similar to the one described above, where the user may preview various media assets that are available for selection. Additionally, the method may include indicating to the user the purpose of the particular segment, so that the user can make an appropriate choice. For example, a title may be displayed, e.g., in the first window, which indicates what the first segment of the media presentation corresponds to. As one specific example, if the media presentation is an advertisement, the first segment may be titled “Get Attention”. Other titles and indications of purpose are envisioned.

In 1206, the user may select or specify a first media asset from the first plurality of media assets using a variety of methods. In one embodiment, the plurality of media assets may be displayed in a file browser window while the user is specifying the address of a particular media asset. Alternatively, or additionally, the user may browse or upload various media assets possibly in addition to the first plurality of media assets presented in 1204. As indicated above, the user may preview various ones of the media assets using a media preview tool (possibly in the first window) while selecting the first media asset.

In 1208 and 1210, a second plurality of media assets may be provided for selection, and the user may select one or more of the media assets for a second segment of the media presentation. The second plurality of media assets may or may not overlap with the first plurality of media assets.

The method may include further presentations of media assets and selections by the user to fully specify the media presentation.

In 1212, the media presentation may be created and/or provided as described above in FIG. 2.

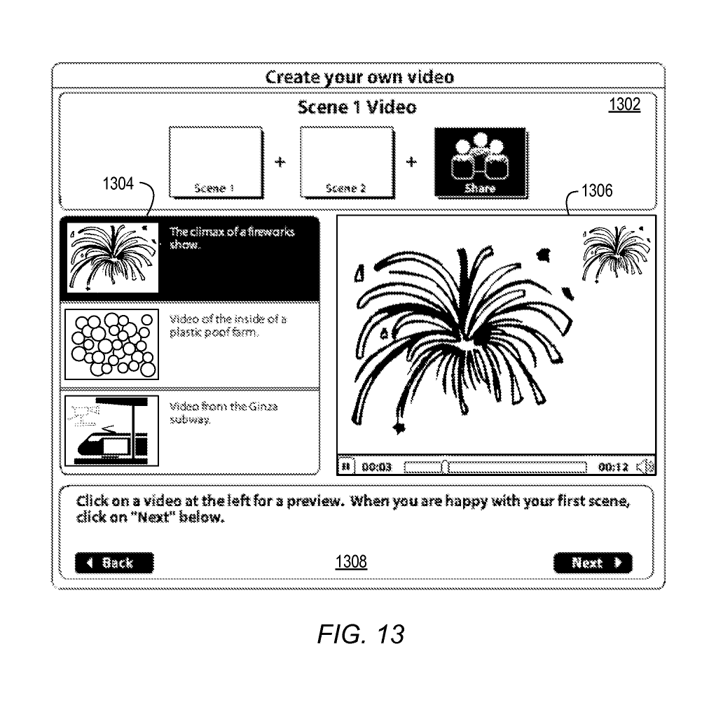

### FIGS. 13-19—Exemplary Screen Shots of the Method of FIG. 12

FIGS. 13-19 are exemplary screen shots corresponding to the method of FIG. 12 (creation of a media presentation using a wizard).

FIG. 13 illustrates an exemplary first window of a wizard which can be used by a user to create a media presentation. As shown, the top portion of the window 1302 may indicate the steps in the process, from beginning to completion. In this case, the top portion indicates that two scenes are to be specified, and then the media presentation may be shared.

On the left 1304, the user may select one media asset from the three available media assets, and may preview each media asset using the media player on the right. As shown, the media player 1306 may include a play or pause button, a volume control, an indication of the current time, and a slider which indicates the current position of the video and may be used as a control to move forward or backwards in time in the asset.

In this particular case, the user has selected “the climax of a fireworks show” as the media asset for the first segment (as identified at the top “Scene 1 Video”). The user could have chosen “Video of the inside of a plastic poof farm” or “video from the Ginza subway”.

In the bottom portion 1308, instructions are displayed—“Click on a video at the left for a preview. When you are happy with your first scene, click on ‘Next’ below”. The user can also choose “next” or “back” on the bottom portion to edit previous or next portions of the media presentation.

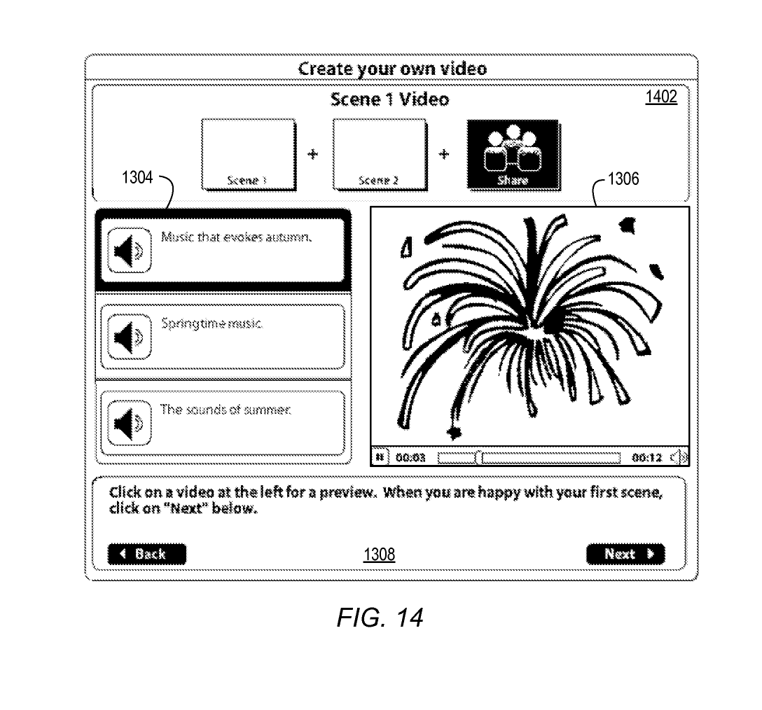

In FIG. 14, after the user has selected “Next” of FIG. 13, the user may select background audio for the previously selected fireworks scene. In this case the user has selected the first option “Music that evokes autumn” from the three choices, which also include “Springtime music” and “The sounds of summer”. In this Figure, the instructions state “Click on a soundtrack to preview the audio for this scene. When you're happy with your selection, click ‘Next’.”

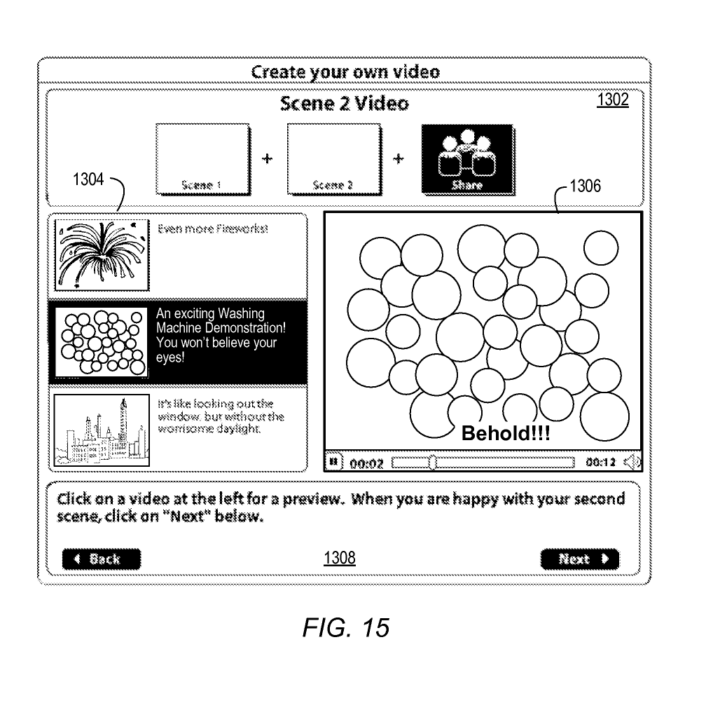

In FIG. 15, after the user has selected “Next” of FIG. 14, the user selects a video for the segment second (as indicated in the top portion “Scene 2 Video”). In this case, the user has the same options as in the first scene, and has selected “An exciting Washing Machine Demonstration! You wont' believe your eyes!”.

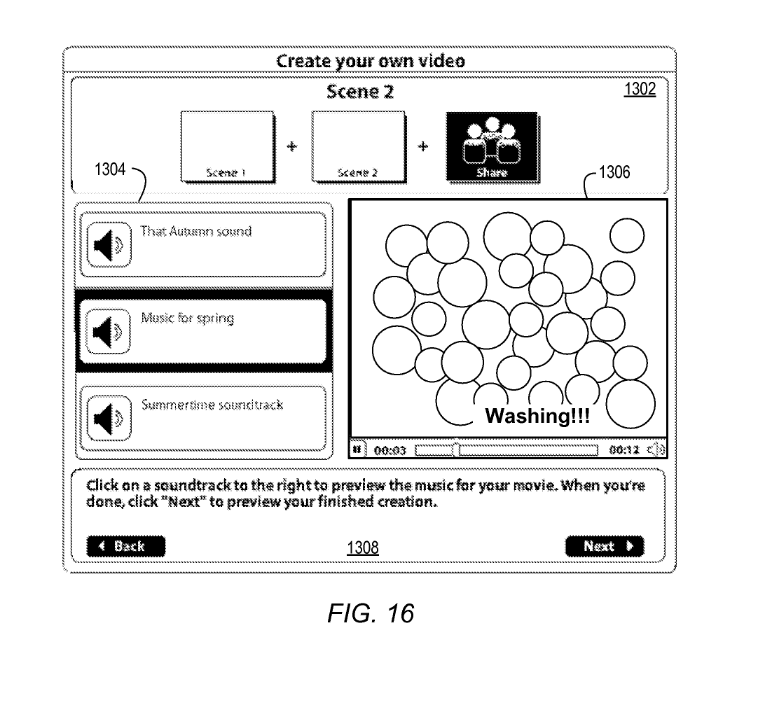

After selected “Next”, the user selects the soundtrack for this scene in FIG. 16. As shown, the user has selected “Music for Spring”.

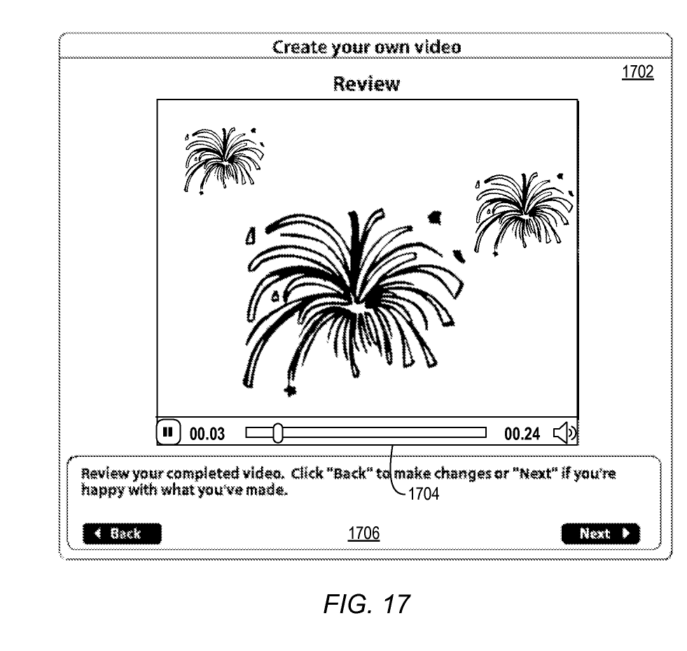

In FIG. 17, the user may review the entire media presentation using media player 1702, which includes all of the media assets chosen by the user. As shown, there is a divider 1704 in the slider of the media player which indicates the transition from segment 1 to segment 2. At the bottom 1706, the instructions state “Review your completed video. Click ‘Back’ to make changes or ‘Next’ if you're happy with what you've made”.

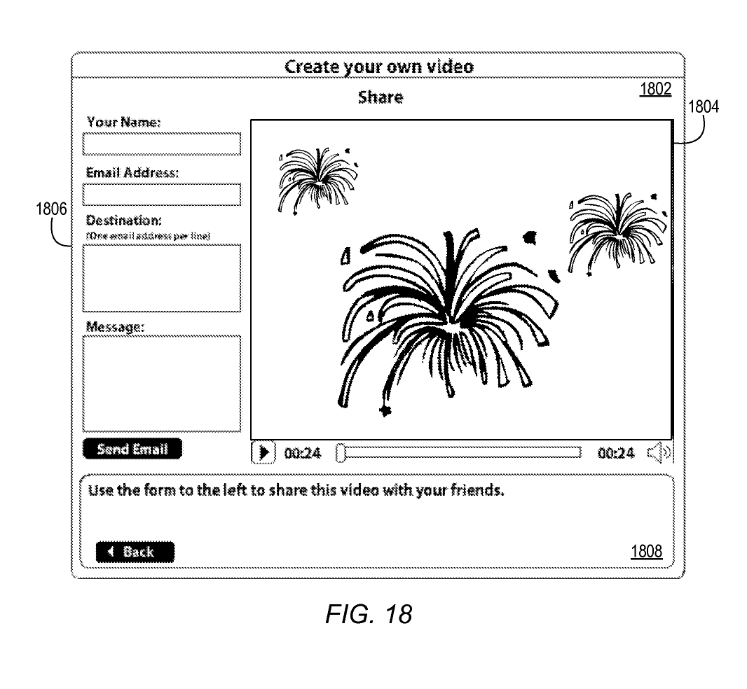

In FIG. 18, the user may share the video. As shown, the user is presented with the title “Share” at the top 1802, a media presentation 1804 on the right, and a series of forms 1806 to fill out on the left. The forms include “Your Name”, “Email Address”, “Destination”, “Message”, and a “Send Email” button which allows the user to share the video. On the bottom 1808, the Instructions state “Use the form on the left to share this video with your friends”.

FIG. 19 illustrates a different example where the user may select a media asset for a first segment or scene of a media presentation. In this case, the title 1902 “Global Warming—Get Their Attention” indicates to the user the purpose of the initial scene. The user can then choose between different visuals 1904, including “Decreasing Carbon Dioxide Emissions”, “Climate Change on Planet Earth”, “Polar Ice Caps Melting” (currently selected), and “Alternative Forms of Energy”. The user may also view the corresponding scene using media player 1906.

The user may click the “next: choose a narrative” button to choose a narrative for the first segment, followed by captions (as indicated on the bottom right) as shown in 1908. Similar screens follow for the next scenes of the video in this embodiment.

Thus, FIGS. 13-19 present exemplary screen shots of a method for specifying a media presentation using a wizard.

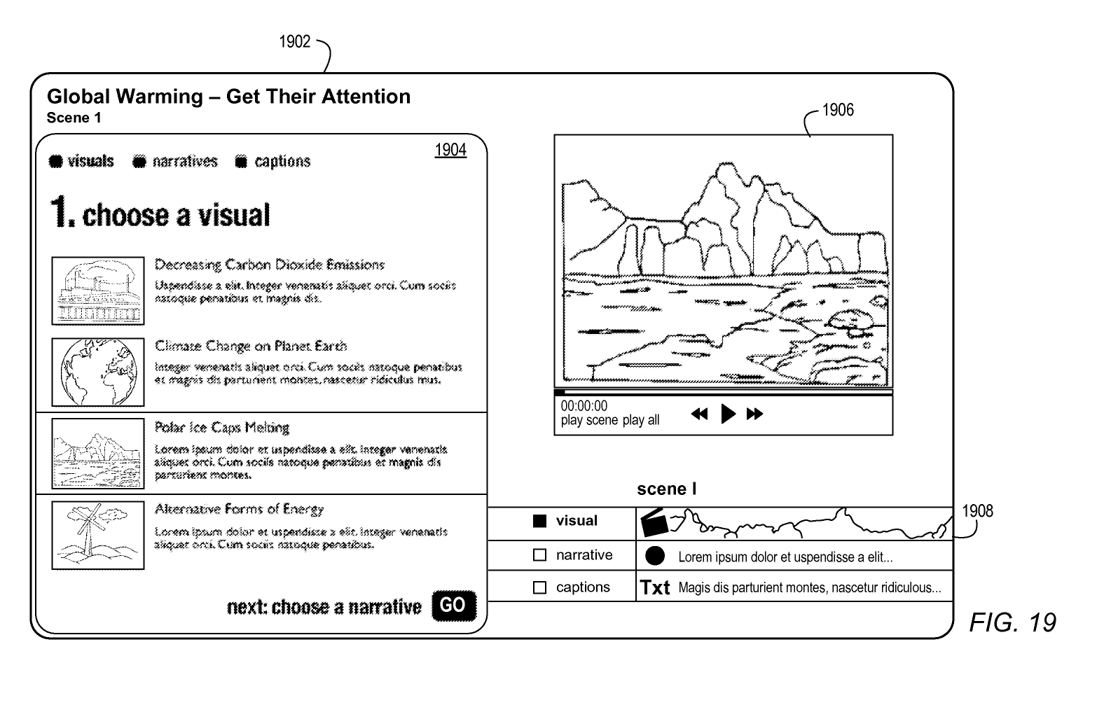

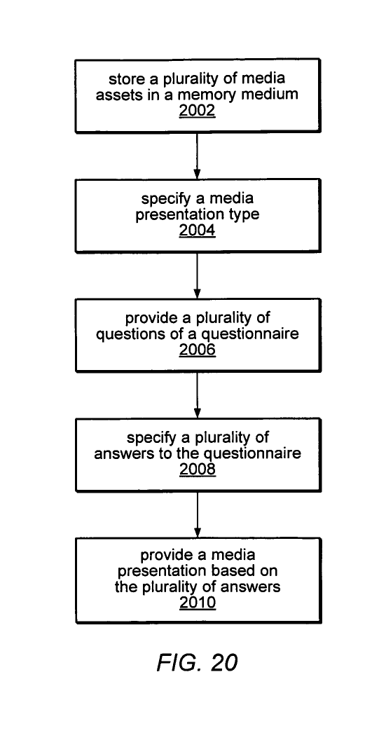

### FIG. 20—Exemplary Method for Creating a Media Presentation Using a Questionnaire

FIG. 20 illustrates a method for creating a media presentation using a questionnaire. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 2002, a plurality of media assets may be stored in a memory medium. The media assets may be stored on a web server or the user's local computer, as desired. The media assets may be used for creation of a media presentation, similar to methods described above.

In 2004, the user may specify a media presentation type, e.g., as described above in 202 of FIG. 2.

In 2006, a plurality of questions in a questionnaire may be presented to the user, and in 2008, the user may provide a plurality of answers to at least a subset of the questions of the questionnaire. The questions of the questionnaire may or may not be based on the media presentation type specified in 2004, depending on whether the user specified the media presentation type. The questions of the questionnaire may operate to establish the user's opinion on a given topic, determine which media assets should be included in the media presentation, or may be used to determine a template or wizard to launch after the user has provided the answers in 2008.

The user may provide answers to the questionnaire via a variety of methods. In some embodiments, the questions may be multiple choice, and the user may select one of the available answers. Similarly, the questions may be simple yes or no questions. Alternatively, or additionally, the user may be able to specify his own answers, e.g., using a keyboard or other technique for specifying the answers to the questions. Thus, the questions may be in a variety of formats and the user may answer them via a variety of methods.

In one embodiment, the questionnaire may be dynamic. For example, the questions of the questionnaire may change based on the user's answers to previous questions. In some embodiments, the first question of the questionnaire may establish a topic or type of presentation, and subsequent questions may correspond to the answer of the first question. Thus, some of the questions of the questionnaire may depend on the answers to previous questions in the questionnaire.

Furthermore, some of the questions of the questionnaire may indicate which media assets should be included in the media presentation. For example, if the user answers yes to a question such as “Do you believe global warming is causing ice to melt in the Northern Hemisphere?”, then a media asset corresponding to the melting of ice in the Northern Hemisphere may be automatically included in the media presentation (or the media presentation template/wizard). However, some questions of the questionnaire may indicate whether media assets should be excluded from the media presentation. In some embodiments, media assets may be by default included in or excluded from the media presentation, but the default may be changed based on individual or a plurality of questions.

In some embodiments, after answering the questions, the user may be presented with a plurality of media assets arranged in a sequence according to the answers of the questions. More specifically, in one embodiment, the user may be presented with a template similar to ones described in FIG. 2, and the user may fully specify the media presentation using those methods described above. However, the media presentation template may be chosen based on the answers to the questions to the questionnaire. Similarly, the user may be presented with a wizard such as those described above, where the wizard and/or the particular assets shown in the wizard are selected based on the answers to the questions in the questionnaire.

In 2010, the media presentation may be created and/or provided to the user similar to the methods described above in FIG. 2. The media presentation may be created or provided in response to completion of a template, a wizard, or simply at the conclusion of the questionnaire. In other words, the questionnaire may result in a fully made (automatically created) media presentation for the user without any further user input. However, as indicated above, the user may modify the media presentation using a provided template or wizard prior or subsequent to the creation/provision of the media presentation. In other words, the questionnaire may result in a corresponding template and then a media presentation from that template or may result in a presentation and then a template for further modification. Alternatively, in simpler embodiments, the answers of the questions may be used to directly create a media presentation. Thus, the user may answer a series of questions in a questionnaire to create a media presentation.

### FIGS. 21-42—Exemplary Screen Shots Corresponding to the Method of FIG. 20

FIGS. 21-42 are exemplary screen shots corresponding to the method of FIG. 20 (creation of a media presentation using a questionnaire).

FIG. 21 is an introduction screen, which states “In less than a minute, help us make a custom video message to support your rights”.

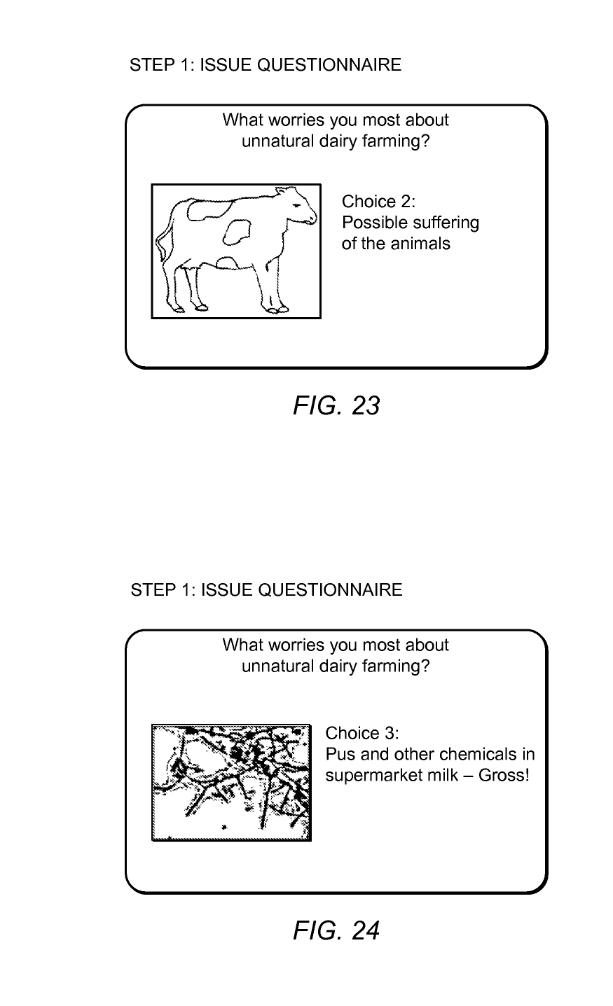

FIG. 22 is step 1 of the process which asks “What worries you most about unnatural dairy farming?”. As shown, the first choice is “health of children and other milk drinkers”. FIG. 23 shows the second choice, “Possible suffering of the animals”, and FIG. 24 shows the final choice, “Pus and other chemicals in supermarket milk—Gross!”.

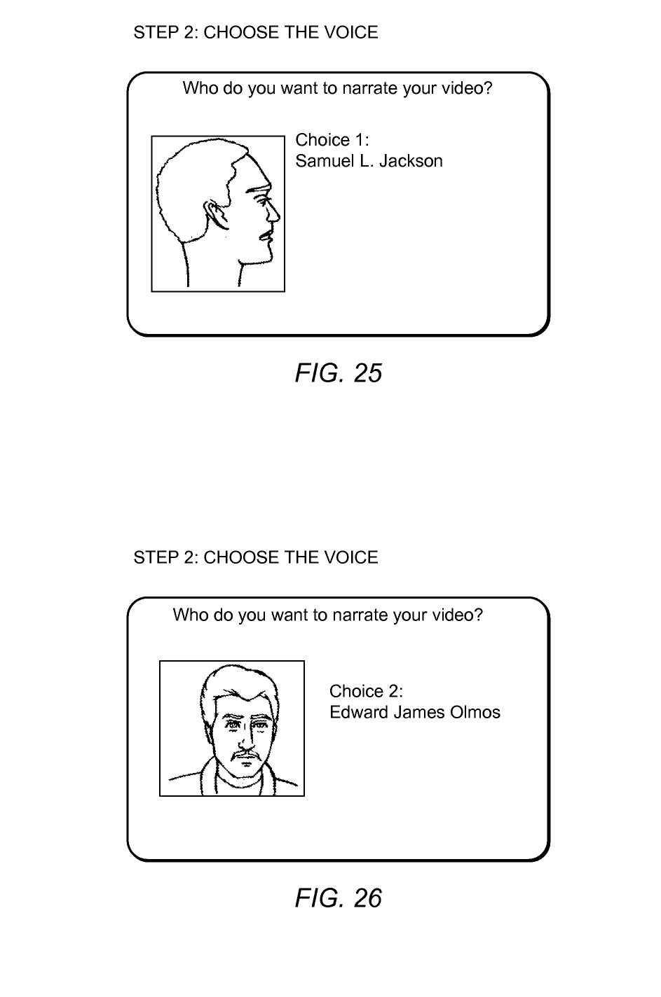

FIG. 23 allows the user to choose a narrator; as shown, the first choice is Samuel L. Jackson. FIG. 24 allows the user to choose James Olmos, and FIG. 25 allows the user to choose Leonardo diCaprio.

In FIG. 28, an introduction is created. More specifically, the key message of the introduction is “Many leading companies want to let you know that they don't use rBGH treated dairy products”, “Monsanto, the company selling rBGH, is attacking your right to know by trying to restrict voluntary labeling”, and “so, why should you care if rBGH was used to produce your dairy products?”.

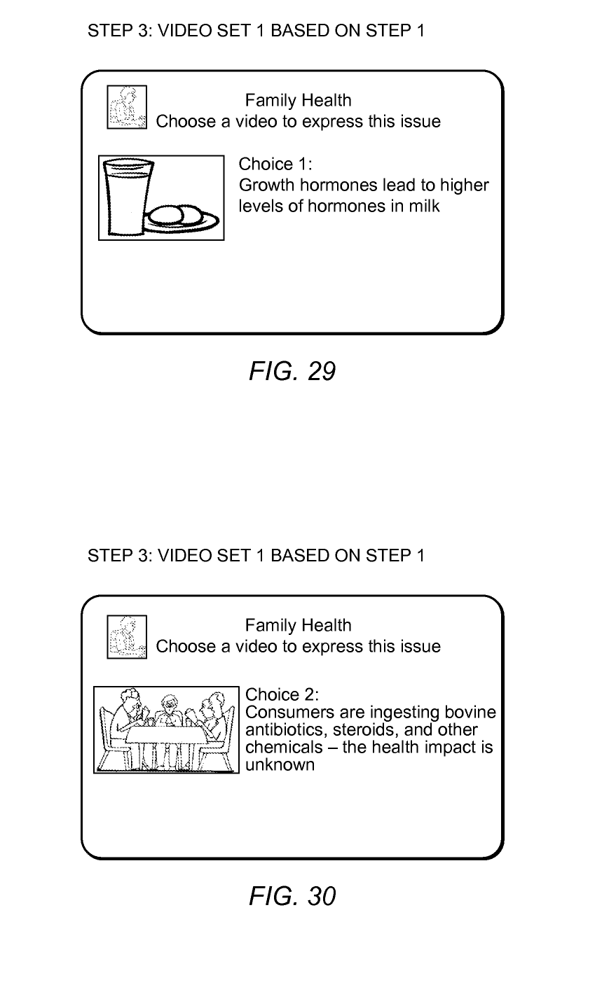

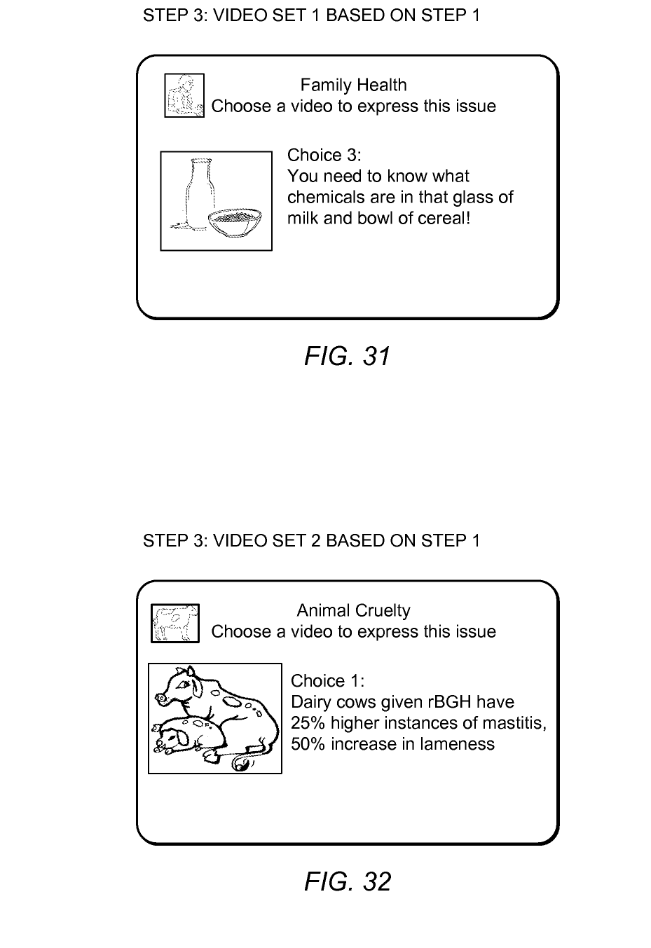

FIG. 29 illustrates the first choice of video if the user has selected “Family Health” in the first section (in this case, the choice of FIG. 22). As shown, the user may choose “growth hormones lead to higher levels of hormones in milk” in FIG. 29, “consumer are ingesting bovine antibiotics, steroids, and other chemicals—the health impact is unknown” in FIG. 30, and “you need to know what chemicals are in that glass of milk and bowl of cereal” in FIG. 31. In this case, these choices correspond to video assets that will be included in the media presentation.

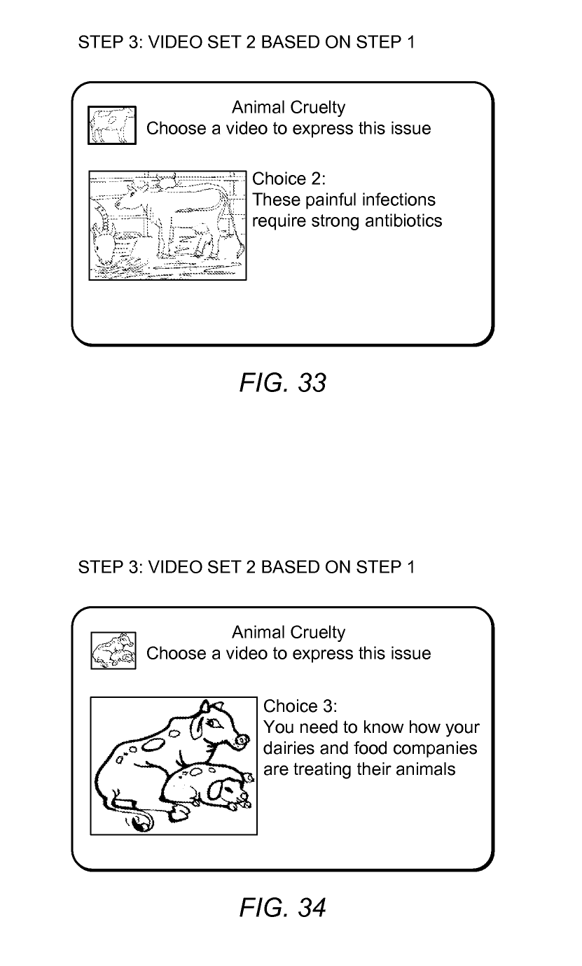

FIG. 32 illustrates the first choice of video if the user has selected “Animal Cruelty” in the first section (in this case, the choice of FIG. 23). As shown, the user may choose “Dairy cows given rBGH have 25% higher instances of mastitis, 50% increase in lameness” in FIG. 32, “These painful infections require strong antibiotics” in FIG. 33, and you need to know how your dairies and food companies are treating their animals” in FIG. 34.

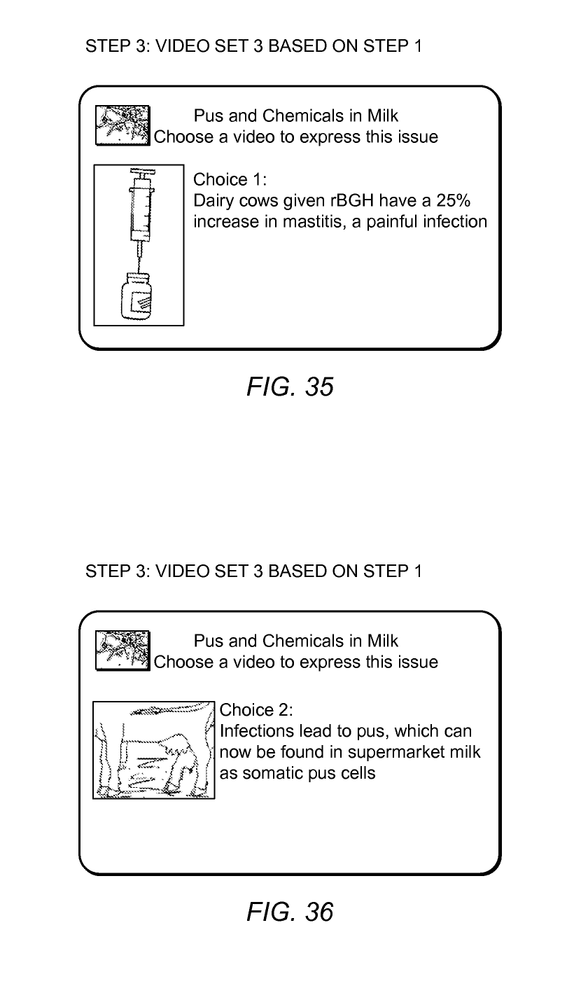

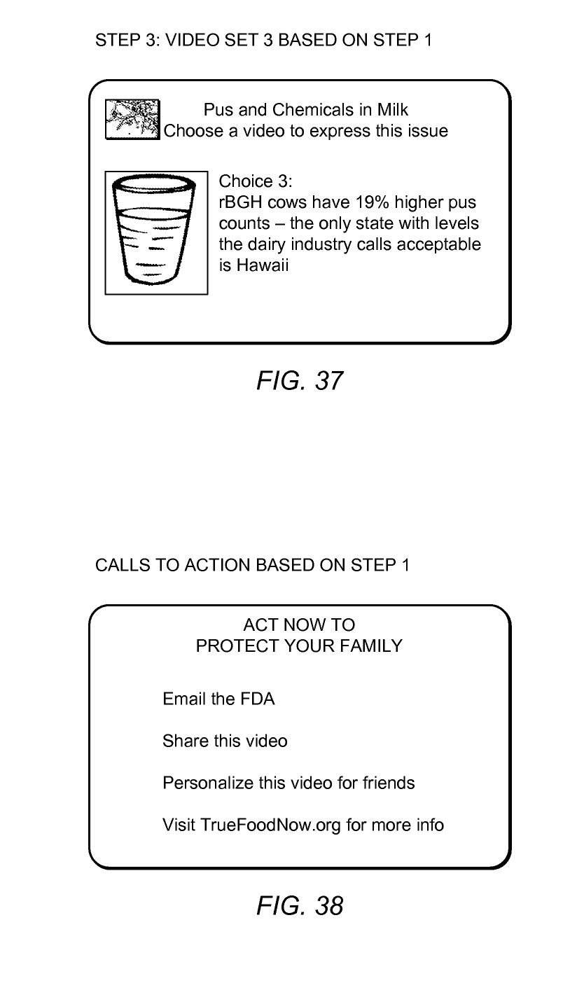

FIG. 35 illustrates the first choice of video if the user has selected “Pus and Chemicals in Milk” in the first section (in this case, the choice of FIG. 24). As shown, the user may choose “Dairy cows given rBGH have a 25% increase in mastitis, a painful injection” in FIG. 35, “Infections lead to pus, which can now be found in supermarket milk as somatic pus cells” in FIG. 36, and “rBGH cows have 19% higher pus counts—the only state with levels the dairy industry calls acceptable is Hawaii” in FIG. 37.

In the Figures described above, the video choices may be previewed by the user, as desired.

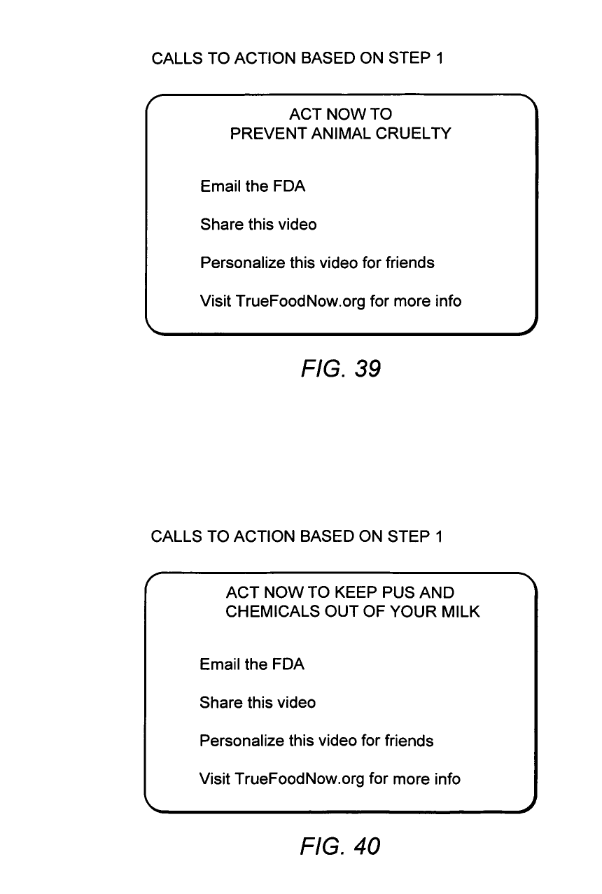

FIG. 38 indicates calls to action based on the choices of the user, which may be used as a final portion of the video. More specifically, the user may email the FDA, Share this video, Personalize this video for friends, or visit TrueFoodNow.org for more info. This particular screen is based on protecting your family. Similar options are provided in FIGS. 39 and 40 for preventing animal cruelty and keeping pus and chemicals out of your milk.

FIG. 40 allows the user to share the video with friends by emailing to friends with a personal message, embed it on the user's web page, or get a link to forward to friends. The user may provide their name, email address, destination, message, send the email, and possibly preview the video created based on the user's answers to the questionnaire.

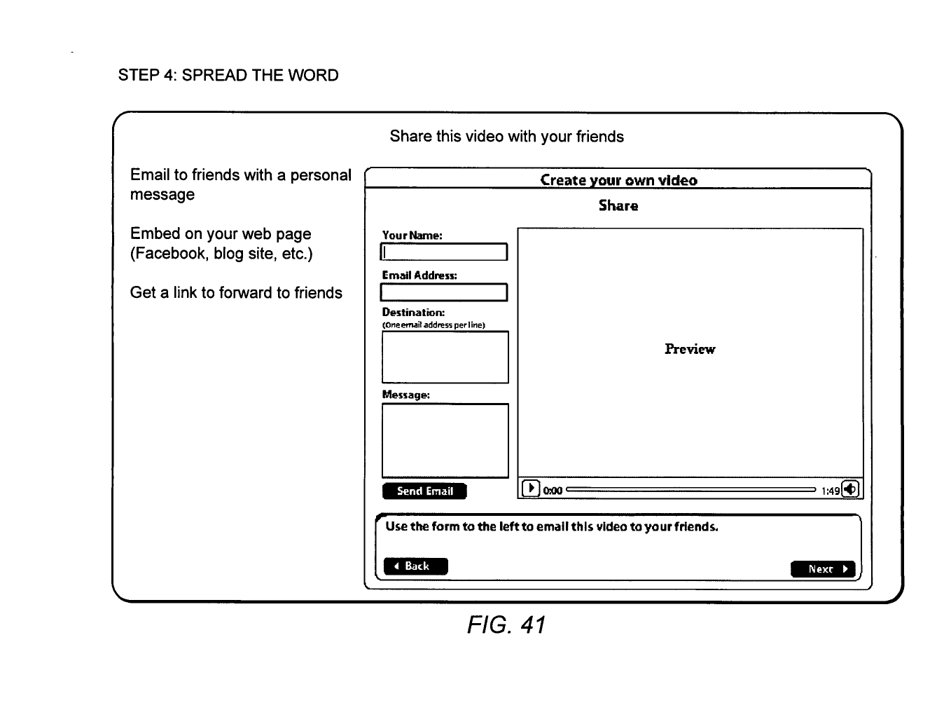

FIG. 41 presents an alternate embodiment of a questionnaire that the user may answer for creation of a media presentation. As shown, the user may “Make your own personal Public Service Announcement in 3 easy questions!”. The first question is “I belong to: SEUI, A Church, A Women's Organization, The IGood Foundation”, where the options are presented as checkboxes. This question may affect the “hello” message (e.g., the first portion) of the media presentation. For example, there may be a slide or other media corresponding to, “This message brought to you by [sponsor name] in Partnership with [other sponsor names]”.

The second question is, “I don't have time for: environmental issues, woman's issues, helping children, helping others, I have time!”, where the options are presented as checkboxes. This question may be used to create a media presentation (or provide selections for creating a video) with the issues indicated by the user. For example, if the user selects environmental issues and helping others in this question, the media presentation may correspond to women's issues and helping children.

Finally, the third question is “Who could speak for me? a southerner, someone who knows what it is like to be an immigrant, a man, a woman”, where the options are presented as checkboxes. This question may be used to select a narrator of the video. These questions may be used to generate a wizard, a template, or a completed media presentation, as described above.

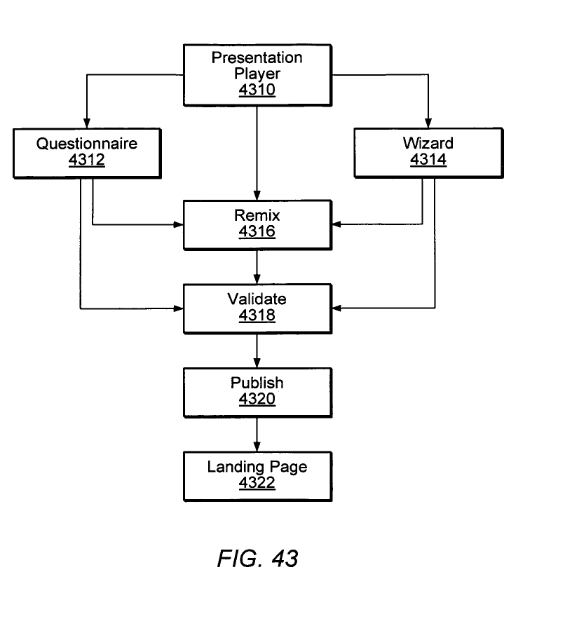

### FIGS. 43-48—Further Embodiments

FIGS. 43-48 are further embodiments which incorporate the above-described methods.

FIG. 43 is a process overview view of the presentation creation and publication system. In FIG. 43, the Presentation Player 4310 represents a webpage on which the presentations already made may be displayed. This marks the most likely place where a user will enter into the system for creating presentations which is the subject of this invention.

From the Presentation Player 4310 the user may go to any of the Questionnaire 4312, Wizard 4314 or Remix 4316 (where the user may modify an existing media presentation) depending on the way the system has been configured, and the options selected by the user. In any case, the appropriate presentation template may be used for the presentation creation.

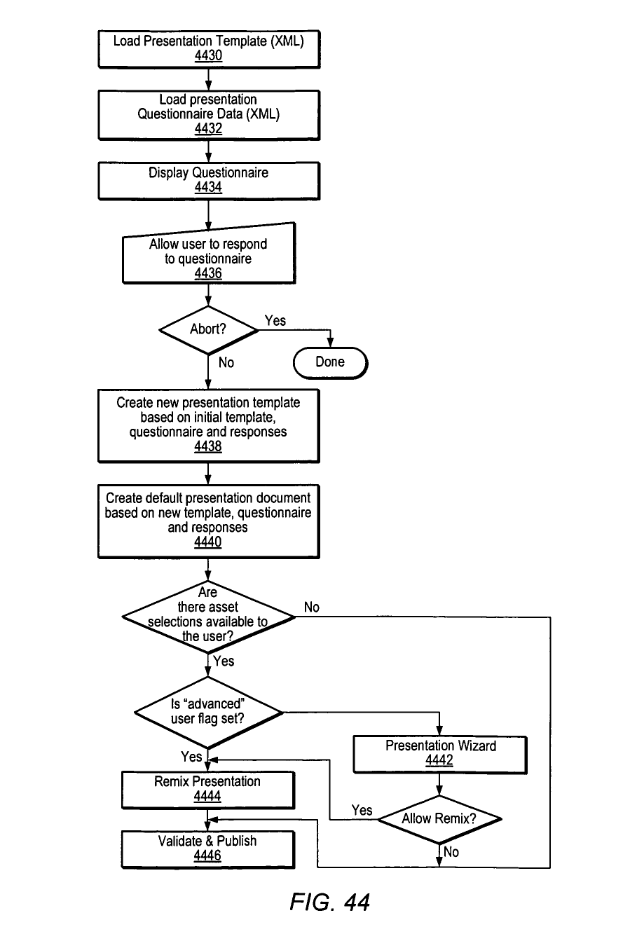

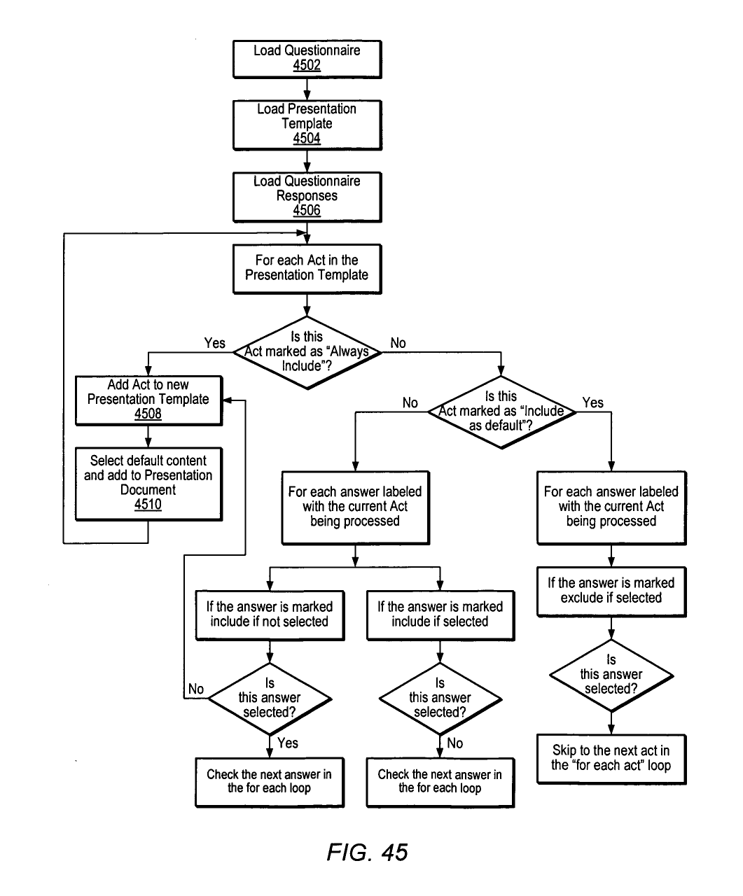

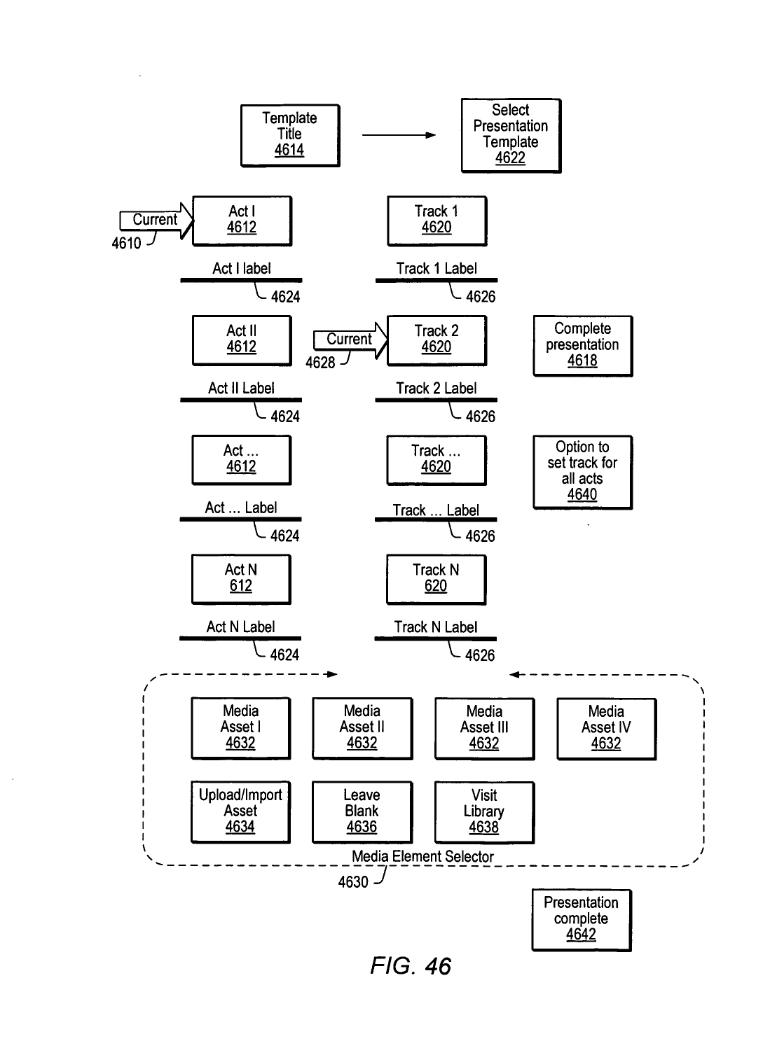

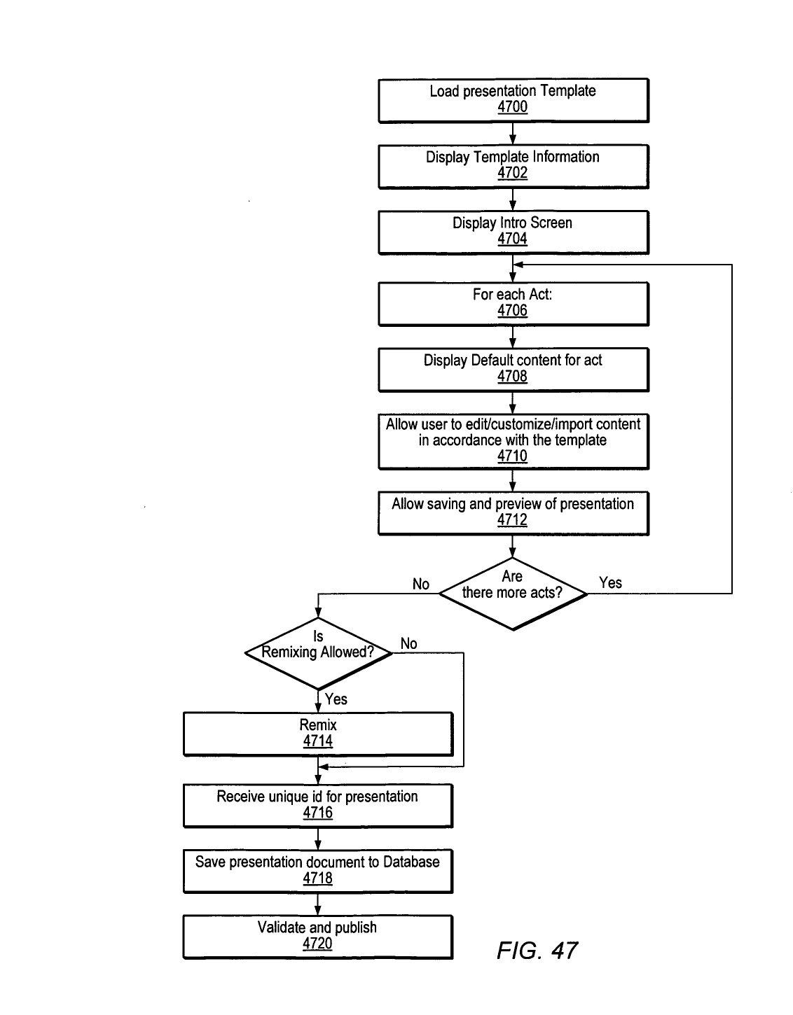

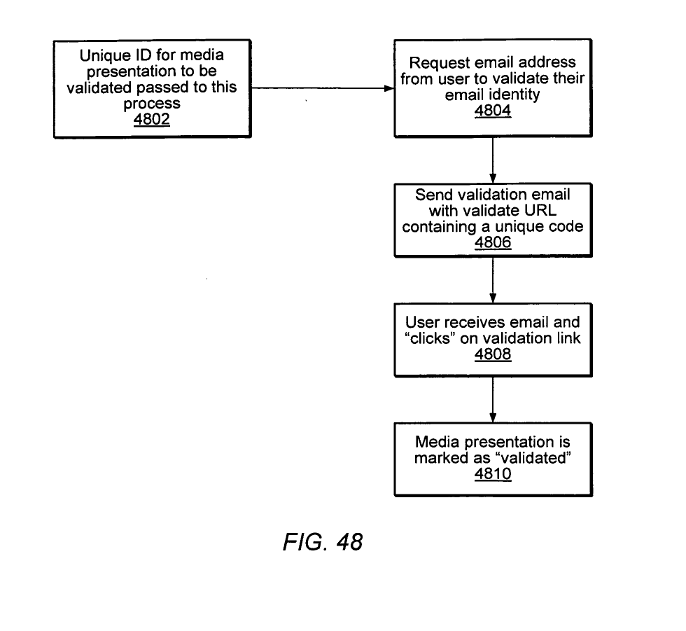

The Questionnaire 4312 may follow the questionnaire 4312 process summary in FIG. 44 and FIG. 45. The Wizard 4314 is detailed in FIG. 46 and FIG. 47. Validate 4318 is detailed in FIG. 48. Publish 4320 and Landing Page 4322 may include standard functions for distributing presentations (e.g., sending emails with a link to the landing page 4322 containing the presentations). The presentation viewing landing pages may be used to view already created presentations.

FIG. 44 is a process summary view of a presentation questionnaire 4312 processing system. As shown, a presentation template may be loaded in 4430, and may be an XML file. Next, in 4432, a questionnaire data may be loaded (possibly another XML file). In 4434, the questionnaire may be displayed, and the user may respond to the questionnaire in 4436. If the user does answer (i.e., does not abort), a new presentation template may be created based on the initial template, the questionnaire, and the responses to the questionnaire in 4438. In 4440, a default presentation template may be created based on the new template, questionnaire, and responses. If there are asset selections available to the user, the user may proceed to a presentation wizard 4442 (or template as described above), and may be able to change or modify the presentation in remix 4444. If there are no choices and/or after completing the presentation via the wizard, remix, or template, the presentation may be validated and published in 4446.

FIG. 45 is a process summary view of a system for creating a new presentation template from an initial presentation template, a questionnaire 4312, and the results from a questionnaire 4312. In some embodiments, acts may be marked “include by default” or “exclude by default” (indicated by not be marked as “include by default”). The questionnaire 4312 answers are all labeled as to the act to which they pertain and whether selecting that answer includes or exclude that act. The initial presentation template, along with the selections from the user and the questionnaire 4312 are processed to create a new presentation template and default presentation document which conforms to the new presentation template.

More specifically, the method shown in FIG. 45 flows as follows, a questionnaire and a presentation template are loaded (4502 and 4504), and the user may answer the questionnaire thereby generating questionnaire responses in 4506. For each act in the presentation template, if the act is marked as “always include” the act is added to the presentation template in 4508, and default content may be added to the presentation document in 4510. If the act is not marked as “always include” and if the act is marked as “include by default”, unless one of the responses of the user indicates that the act should be excluded (e.g., in cases where a question labeled with the particular act as “exclude”), the act is included in 4508. The same procedure is followed for each act in the sequence.

FIG. 46 is an interface summary view of an example of a single page implementation similar to FIGS. 6-11 described above.

Similar to descriptions above, the title of current screen 4614 gives the user a one line title for the presentation being created; this title may indicate the presentation type which is being produced, such as “short public service announcements”. As shown in FIG. 46, the system may allow the user to select from a variety of templates from the presentation template selection interface 4622. However, if the application were meant to help the user create public service announcements, it may only provide the public service announcement template. The interface displayed in FIG. 46 is for a template with a four act presentation Act I having four tracks. Tracks 3 and 4 allow the user to load content into those tracks which is used across all of the Acts.

In the example in FIG. 46, default assets may be placed in each of the tracks and acts used in the current presentation template. Since there are placeholders for one or more tracks 4620 as well as placeholders for one or more acts 4612, there is a complete presentation to view from the beginning of the production process. From time to time, the user may want to play the preview of the complete presentation 4618 in order to see how the entire presentation looks with their current selections.

The presentation is made up of a set of one or more acts 4612. The current act indicator 4610 tells the user which act is currently being modified. The user can select the preview of act 4612 to see the current composition for the act, or select a different act to manipulate. As a default, the placeholder for one or more acts is set for the act and in the preview of act 4612. A template specific act label set 4624 may help to guide the user in creating content which achieves the goals of the current presentation template.

An act may be composed of a set of one or more tracks 4620. Act may or may not contain the same number of tracks. The current track indicator 4628 tells the user which track is currently being manipulated. The user may select the preview of track 4620 to view the currently selected track within an act, or across all acts. In some situations the user may be able to change the tracks within each act, in other situations the user may be selecting a track to use across all the acts, such as a narration which will be used across all of the acts and guide their other creative choices. The default for the option to set track for all acts 4640 is OFF. Depending on the template used, the option to set track for all acts 4640 may be set to ON for one or more tracks by the application and may or may not be alterable by the user. The selection of assets which provide content across all of the acts may determine the setting for this option as well. A template specific track label set 4626 may guide the user in achieving the goals of the current presentation template while manipulating the track content. In other words, the track or act labels may indicate to the user a purpose of the specific act or track. A set of template specific labels 4626 may be used for elements.

The core of the user creation and creativity may take place within the asset selection interface 4630. Here the user can select from a small list of assets provided through the system via the provided asset selection options 4632. The user may add other content for use in the production via the upload asset option 4634. In some situations, they user may be allowed to leave a track, act, or combination thereof blank by using the option to leave slot blank 4636. Additional assets may be accessed via the option to visit asset library 4638.

When the user is done with their creative work, or wishes to save it for later work, they may use the presentation complete button 4642 to tell the application to publish or save the current workspace.

FIG. 47 is a process summary view of a presentation creation wizard 4314. As shown, in FIG. 47, in 4700 the template may be loaded, in 4702, the template information may be displayed, and in 4704, an intro screen may be displayed. For each act, in 4706, the default content may be displayed, in 4708, the user may edit, customize, and/or import in accordance with the template in 4710, and in 4712, the user may save and/or preview the presentation. This process is repeated for at least a subset of the acts of the media presentation.

Correspondingly, if remixing (that is, modification of the media presentation, possibly by reorganizing tracks or applying various effects) is allowed, the user may remix the presentation in 4714. Finally, a unique ID may be generated for the presentation (4716), the presentation may be saved as a document in a database in 4718, and the presentation may be validated and published in 4720.

FIG. 48 is a process summary view of a user validation system. More specifically, in FIG. 48, a unique ID is received in 4802, an email address may be requested from the user for validation in 4804, a validation email may be sent to the user with a unique code in 4806, the user may return with the unique ID in 4808 (e.g., by clicking a validation link in the email), and the media presentation may be marked as validated in 4810.

Thus, FIGS. 43-48 present embodiments of the combination of the methods described above.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for creating a media presentation, the method comprising:
displaying a media presentation template, wherein the template comprises a sequence of segments, wherein the segments are graphically illustrated on the display, wherein the segments in the sequence of segments have a first ordering, wherein for each of at least a subset of the segments, at least one media asset icon representing a media asset is associated with the respective segment, wherein a first segment comprises a plurality of selectable media asset icons, each of the plurality of selectable media asset icons representing a respective media asset usable for the first segment;
wherein, in a first mode, media assets corresponding to respective segments in the template are restricted to use only in the respective segments of the media presentation;
receiving user input selecting one of the selectable media asset icons from the plurality of selectable media asset icons for the first segment;
providing the media presentation, wherein the media presentation comprises the sequence of segments, wherein the media presentation comprises the selected media asset for the first segment.

2. The method of claim 1,
wherein, in a second mode, the first ordering of the segments is not changeable by the user.

3. The method of claim 1,
wherein the first ordering of the segments is not changeable by the user.

4. The method of claim 1,
wherein at least a subset of the media asset icons each comprise an image corresponding to its respective media asset.

5. The method of claim 1,
wherein the media asset icons corresponding to the sequence of segments are displayed in one of a 1) left to right or 2) top to bottom manner.

6. The method of claim 1, further comprising:
viewing the media presentation; and
displaying the template during said viewing, wherein the media presentation is operable to be modified by a user using the template during said viewing.

7. The method of claim 1, wherein the media assets comprise one or more video files.

8. The method of claim 1, wherein the media assets comprise one or more images.

9. The method of claim 1, further comprising:
receiving a new media asset; and
associating the new media asset with a segment of the plurality of segments.

10. The method of claim 1, wherein said providing the media presentation comprises providing a pre-made media presentation which corresponds to the received user input.

11. The method of claim 1, further comprising:
providing a plurality of media presentation types for selection by a user;
receiving user selection of a media presentation type from the plurality of media presentation types;
wherein the media presentation template corresponds to the selected media presentation type.

12. A computer-accessible memory medium comprising program instructions for creating a media presentation, wherein the program instructions are executable by a processor to:
display a media presentation template, wherein the template comprises a sequence of segments, wherein the segments are graphically illustrated on the display, wherein the segments in the sequence of segments have a first ordering, wherein for each of at least a subset of the segments, at least one media asset icon representing a media asset is associated with the respective segment, wherein a first segment comprises a plurality of selectable media asset icons, each of the plurality of selectable media asset icons representing a respective media asset usable for the first segment;
wherein, in a first mode, media assets corresponding to respective segments in the template are restricted to use only in the respective segments of the media presentation;
receive user input selecting one of the selectable media asset icons from the plurality of selectable media asset icons for the first segment;
provide the media presentation, wherein the media presentation comprises the sequence of segments, wherein the media presentation comprises the selected media asset for the first segment.

13. The memory medium of claim 12,
wherein, in a second mode, the first ordering of the segments is not changeable by the user.

14. The memory medium of claim 12,
wherein the first ordering of the segments is not changeable by the user.

15. The memory medium of claim 12,
wherein at least a subset of the media asset icons each comprise an image corresponding to its respective media asset.

16. The memory medium of claim 12,
wherein the media asset icons corresponding to the sequence of segments are displayed in one of a 1) left to right or 2) top to bottom manner.

17. The memory medium of claim 12, wherein the program instructions are further executable to:
display a portion of the template during viewing of the presentation, wherein a user is operable to modify the media presentation using the template.

18. The memory medium of claim 12, wherein the media assets comprise one or more video files.

19. The memory medium of claim 12, wherein the media assets comprise one or more images.

20. The memory medium of claim 12, wherein the program instructions are further executable to:
receive a new media asset; and
associate the new media asset with a segment of the plurality of segments.

21. The memory medium of claim 12, wherein said providing the media presentation comprises providing a pre-made media presentation which corresponds to the received user input.

22. The memory medium of claim 12, wherein the program instructions are further executable to:
provide a plurality of media presentation types for selection by a user;
receive user selection of a media presentation type from the plurality of media presentation types;
wherein the media presentation template corresponds to the selected media presentation type.

23. A computer-accessible memory medium comprising program instructions for creating a media presentation, wherein the program instructions are executable to:
display a media presentation template, wherein the template comprises a sequence of segments, wherein the segments are graphically illustrated on the display, and wherein said displaying the media presentation template comprises displaying indications which identify a purpose for each segment, wherein the purpose for each segment allows a user to select an appropriate media asset for the segment;
provide a plurality of media assets for association with each segment of the media presentation;
for each segment, receiving user input associating one or more media assets of the plurality of media assets with the segment of the media presentation;
provide the media presentation, wherein the media presentation comprises the sequence of segments, wherein the media presentation comprises the associated media assets.

24. A method for creating a media presentation, the method comprising:
providing a first plurality of media assets for a first segment of a media presentation for display, wherein the first plurality of media assets are only useable for the first segment of the media presentation;
receiving first user input selecting a first media asset for the first segment of the media presentation;
providing a second plurality of media assets for a second segment of the media presentation for display, wherein the second plurality of media assets are only useable for the second segment of the media presentation;
receiving second user input selecting a second media asset for the second segment of the media presentation; and
providing the media presentation, wherein the media presentation comprises the first and the second media assets.

25. The method of claim 24,
wherein said providing the first plurality of media assets for a first segment comprises providing a first plurality of media asset icons for selection by the user.

26. The method of claim 25,
wherein the first plurality of media asset icons are displayed simultaneously on the display.

27. The method of claim 24, wherein said providing the media presentation comprises displaying a first media asset icon and a second media asset icon representing the first and second media assets, respectively, selected by the user.

28. The method of claim 24, wherein the media presentation comprises a video presentation.
